(19) United States
(12) Patent Application Publication
(10) Pub. No.: US 2024/0178441 A1
(43) Pub. Date: May 30, 2024

(54) METHODS OF IMPROVING ELECTRODE STABILITY IN HIGH VOLTAGE ENERGY STORAGE DEVICES

(71) Applicant: Ohio State Innovation Foundation, Columbus, OH (US)

(72) Inventors: Jung Hyun KIM, Plain City, OH (US); Chanyeop YU, Columbus, OH (US); Xinwei JIAO, Hilliard, OH (US)

(21) Appl. No.: 18/284,743

(22) PCT Filed: Mar. 31, 2022
(86) PCT No.: PCT/US2022/022894

§ 371 Date: Sep. 28, 2023

Related U.S. Application Data
(60) Provisional application No. 63/168,633, filed on Mar. 31, 2021.

(51) Int. Cl. H01M 10/0562; H01M 4/02; H01M 4/505; H01M 4/525

(52) U.S. Cl. CPC H01M 10/0562; H01M 4/505; H01M 4/525; H01M 2004/021; H01M 2300/0077

(57) ABSTRACT

Described herein is a solid electric conductor and methods of making and using the solid electric conductor. The solid electric conductor can include two discrete populations of particles intermixed. A first population of particles can include an ionically conducting solid-electrolyte, and a second population of particles can include an electrode active material. The compositions and methods described allow to achieve high specific energy, good cycle/calendar life, and low cobalt (Co) loading to reduce the cost of battery cells.

### CROSS-REFERENCE TO RELATED APPLICATIONS

The application claims the benefit of U.S. Provisional Application No. 63/168,633, filed Mar. 31, 2021, which is hereby incorporated herein by reference in its entirety.

### BACKGROUND

The new paradigm of low-cost electricity derived from renewable energy sources and increasing awareness of climate change is disrupting the transportation sector and driving a rapid-transition to electric mobility. Automakers are investing $300 billion to expand electric vehicles to the mass-market, however, electric vehicles can cost $12,000 than a comparable internal combustion engine vehicle. Battery costs (˜$10,000 for a 50 kWh battery pack at a cost of $200 per kWh) are the single biggest cost driver and cost reductions are required to accelerate automakers transition to mass-market profitability. Reducing battery costs to less than $100/kWh and improving battery efficiency (higher energy density) will half the price differential between electric and internal combustion engine vehicles and provide a roadmap for automakers to achieve a profit margin of between one and two percent by 2025.

As the largest distributed source of CO₂ emissions, the transportation sector is currently experiencing a rapid transition to electric mobility and the adoption of electric vehicles, with 100-million EVs targeted by 2020. This trend is driving the growth in lithium-ion batteries (LIBs), with one percent of the automotive market consuming 60 percent of lithium-ion batteries. Current state-of-the-art LIBs that have been successfully commercialized for EVs are based on high-energy-density layered oxides such as LiNi_{1-x-y}CoₓAl_{y}O₂ (NCA) or LiNi₁₋ₓMn_{0.5x}Co_{0.5x}O₂ (NMC). Next-generation battery technologies, required to accelerate the commercialization of electric vehicles will need to demonstrate lower costs, increased performance (specific energy or energy density), improved cycle life and less reliance on critical raw materials such as cobalt.

A LiB cathode stabilization approach to improve the cycle life of high performance, next-generation cathode materials, which will accelerate their commercial adoption including nickel (Ni)-rich LiNi₁₋ₓMn_{0.5x}Co_{0.5x}O₂ (NMC with x≤0.2) layered oxide, manganese (Mn)-rich Li[LiₓNi_{y}Co_{z}Mn_{1-x-y-z}]O₂ layered oxide, and high-voltage LiNi_{0.5-x}Mn_{1.5-y}M_{x+y}O₄ (M=Ti, V, Cr, Mg, Al, Co, Fe, Cu, Zn) spinel oxide cathodes. All these cathode active materials suffer from unfavorable reaction in contact with electrolyte due to their high operating voltages and catalytic activity of transition metals such as nickel at high state-of-charge (SOC). The unwanted cathode/electrolyte reaction leads to a phase degradation at the surface of active material particle and negatively impact the cell performances. Such surface degradation of cathode active materials becomes critical issue for Ni-rich NMC, in particular, due to its large Ni content (≥80% of transition metals). Since the Ni-rich NMC has attracted great interest for EV applications due to its high specific energy, developing a technology that can effectively passivate its surface and extend the life of LIBs is needed.

Current commercial LiBs, used in large-scale, high-power electric vehicles are based on cobalt-containing (greater than 100 mg/Wh-cell-level) layered oxides LiNi_{0.8}Co_{0.15}Al_{0.05}O₂ (NCA) or NMC. Speculation over a future global shortage of cobalt has led to a rapid increase in cobalt prices and renewed interest in reduced or cobalt-free cathode formulations.

In the automotive industry, transformational changes in battery technologies are needed to move from hybrid electric vehicles to plug-in HEV and all-electric vehicles. The automotive industry is transitioning to vehicle electrification. As Li-ion batteries (LIB) were developed mainly for portable electronics, breakthroughs are still required for transportation applications. There is interest in developing future Li-ion batteries that are light, durable, with high power, high capacity, and low cost by using advanced materials, therefore this area of research is of great interest. In fact, using NMC cathode materials in Volt and Bolt battery packs has been employed. However, to commercialize PHEV and EV, cheaper cathode materials are required to reduce the overall battery cost.

To sustain the continued electrification of our transportation sector there is a need for new battery cathode chemistries that in addition to increasing energy density and cycle life, use low cost, abundant raw materials, reducing the industry's reliance on critical materials such as cobalt that could pose a supply risk in the future.

Therefore, to solve the most critical and urgent issue on high energy batteries for EV applications, there is interest in cathode chemistry that can achieve high specific energy, good cycle/calendar life, and low cobalt (Co) loading to reduce the cost of lithium-ion (Li-ion) battery cells for Electric Vehicles (EVs) applications.

The compositions and methods disclosed herein address these and other needs.

### SUMMARY

Provided herein are solid electric conductors as well as methods of making and thereof. The solid electric conductors can comprise two discrete populations of particles intermixed. The first population of particles can include an ionically conducting solid-electrolyte, and the second population of particles can include an electrode active material.

In some embodiments, the ionically conducting solid-electrolyte can include at least one of the following compounds a) through g):
a) LiPON (lithium phosphorus oxynitride or Li₃PO₄ (lithium phosphate);
b) garnets of general formula Li_{y}A₃B₂O₁₂ in a predominantly cubic crystal structure, where A is selected from at least one element of the group La, K, Mg, Ca, Sr, and Ba, B is selected from at least one element of the group Zr, Hf, Nb, Ta, W, In, Sn, Sb, Bi, and Te, and 3<y<7. A predominantly cubic crystal structure is a crystal structure for which at least 80 vol % is made up of a cubic crystal structure. Particularly preferred are garnets of formula Li_{y}A₃B₂O₁₂, where A=La, and B is selected from Zr, Nb, Ta, and Te. One preferred specific embodiment is garnets of general formula Li₇₋ₓLa₃Zr₂₋ₓMₓO₁₂, where M stands for Nb, Ta, or a mixture of the two elements, and 2≥x≥0, in particular 1.5≥x≥0.5, or 1.5≥x≥0.2 (LLZT). Another preferred specific embodiment is garnets of general formula Li_{7-3z}Al_{z}La₃Zr₂₋ₓMₓO₁₂, where M stands for Nb, Ta, or a mixture of the two elements, 2≥x≥0, in particular 1.5≥x≥0.5 and 0<z<0.3;
c) perovskites of general formula Li₃ₓLa_{2/3-x}TiO₃, where 2/3≥x≥0, in particular 0.5≥x≥0.2;
d) compounds of the NASICON type, represented by general formula Li₁₊ₓRₓM₂₋ₓ(PO₄)₃, where M is selected from at least one element of the group Ti, Ge, and Hf, R is selected from at least one element of the group Al, B, Sn, and Ge, and 0≤x<2. In one specific embodiment x=0. In one preferred specific embodiment M=Ti. One preferred specific embodiment is a compound of general formula Li₁₊ₓAlₓGe_{y}Ti_{2-x-y}(PO₄)₃ (LAGP or LATP), where 0≤x<2, 0≤y<2, and 0≤x+y<2; it is particularly preferred that 0≤x<1, 0≤y<1, and 0≤x+y<2;
e) Lithium-ion-conducting sulfide glasses of general formula x(Li₂S)·y(P₂S₃)·z(MₙSₘ), where MₙSₘ has the meaning SnS₂, GeS₂, B₂S₃, or SiS₂, and x, y, and z may each independently assume a value of 0 to 100, with the condition that x+y+z=100. One preferred specific embodiment is sulfidic glasses where 60≤x≤90, 30≤y≤60, and z=0. It is particularly preferred that x=70, y=30, and z=0. Further preferred specific embodiments are sulfidic glasses having the composition x (Li₂S)·(P₂S₅)·z(GeS₂), where y=z=14 and x=72;
f) argyrodites of formula Li₆PS₅X, where X may be selected from Cl, Br, and I; preferred specific embodiments are Li₆PS₅Cl and Li₆GPS₅Br; Li₆PS₅Cl is particularly preferred; and/or
g) polymer electrolytes based on polyethylene oxide (PEO); for increasing the lithium ion conductivity, the polymer electrolytes preferably include lithium salts selected from lithium hexafluorophosphate (LiPF₆), lithium tetrafluoroborate (LiBF₄), LiSbF₆, LiAsF₆, Li(CF₃)SO₂NSO₂(CF₃) (LiTFSI), LiClO₄, lithium bis(oxalato)borate (Li[B(C₂O₄)₂], LiBOB), and/or lithium difluoro(oxalato)borate (Li[BF₂(C₂O₄)], LiDFOB).

In some embodiments, the electrode active material can include an anode material, a cathode material, or any combination thereof. In some examples, the electrode active material can include layered-structured cathode materials such as LiNi_{0.6}Mn_{0.2}Co_{0.2}O₂ (NMC622), LiNi_{0.8}Co_{0.1}Mn_{0.1}O₂ (NMC811), LiNi_{1/3}Mn_{1/3}Co_{1/3}O₂ (NMC111), LiNi_{0.5}Mn_{1.5}O₄ (LNMO), LiNi_{0.5}Mn_{1.5-x}TiₓO₄, or LiNi_{0.8}Co_{0.15}Al_{0.05}O₂ (NCA), or the like; cubic spinel cathode materials such as LiM₂O₄ (where M=Mn, Co, Ni, Al, Ti, Mg, combination thereof and the like); olivine materials such as LiMPO₄ (where M=Fe, Co, Mn, combination thereof and the like); or any combination thereof.

In some embodiments, the electrode active material can be manganese rich. In some embodiments, the electrode active material can be represented by formula I:

Li_{1+z}(Ni_{1-x-y}MnₓCo_{y})_{1-z}O₂
wherein y is less than 0.12, x is greater than 0.5, and z is 0.13. In some embodiments, the electrode active material can be Li_{1.13}Ni_{0.28125}Mn_{0.53125}Co_{0.1875}O_{2.13}.

In some embodiments, the electrode active material can be nickel rich. In some embodiments, the electrode active material can be represented by formula II:

LiNi_{1-x-y}MnₓCo_{y}O₂
wherein x is less than 0.1; and y is less than 0.1.

In some embodiments, the electrode active material can be represented by Formula III:

LiNi₁₋ₓCo_{0.5x}Mn_{0.5x}O₂
wherein x is 0.15 or 0.1.

In some embodiments, the electrode active material can be LiNi_{0.85}Co_{0.075}Mn_{0.075}O₂, LiNi_{0.9}Co_{0.05}Mn_{0.05}O₂, LiNi_{0.5}Mn_{1.5-x}TiₓO₄, LiNi_{0.8}Co_{0.15}Al_{0.05}O₂, or the like.

In some embodiments, the positive electrode active material can be represented by a formula Li_{1+b}Ni_{α}Mn_{β-δ}Co_{γ}M_{δ}O_{2-z}F_{z}, where b ranges from 0.01 to 0.3, a ranges from 0 to 0.4, β ranges from 0.2 to 0.65, γ ranges from 0 to 0.45, δ ranges from 0 to 0.15 and z ranges from 0 to 0.2, and where M can be Mg, Zn, Al, Ga, B, Zr, Ti, Ca, Ce, Y, Nb or combinations thereof.

In some embodiments, the negative electrode of the battery can include graphite, synthetic graphite, hard carbon, graphite coated metal foil, carbon nanotube, carbon nanofiber, or a combination thereof.

In some embodiments, the electrode active material can further include a binder, a carbon conductive material, a passivation layer, or any combination thereof.

In some embodiments, the first population of particles can exhibit an average particle size of from 20 nm to 30 μm. In some embodiments, the second population of particles can exhibit an average particle size of from 20 nm to 30 μm. In some embodiments, the first population of particles can exhibit an average particle size and the second population of particles can exhibit an average particle size, and wherein the average particle size of the first population of particles can be from 0.005 to 200 of the average particle size of the second population of particles. In some embodiments, the first population of particles, the second population of particles, or any combination thereof can have a spherical shape. In some embodiments, the first population of particles and the second population of particles can be present in a weight ratio of from 1:1000 to 1:5.

In some embodiments, the first population of particles can be physically blended with the second population of particles. In some embodiments, the first population of particles can be wet-chemically coated on the second population of particles. In some embodiments, the first population of particles can be physically absorbed by the second population of particles.

Described herein are also methods of making a solid electric conductor. In some embodiments, the method can include contacting a first population of particles including an ionically conducting solid-electrolyte described herein with a second population of particles including an electrode active material described herein.

In some embodiments, the electrode active material and the ionically conducting solid-electrolyte can be in the form of a powder. In some embodiments, contacting the electrode active material with the ionically conducting solid-electrolyte can include physically blending the ionically conducting solid-electrolyte and the electrode active material. In some embodiments, the physical blending can include mechanical mixing or dropcast mixing.

In some other embodiments, contacting the electrode active material with the ionically conducting solid-electrolyte can include wet chemical coating the ionically conducting solid-electrolyte on the electrode active material. In some embodiments, the wet chemical coating can include a sol-gel, hydrothermal, or solvothermal synthesis process.

In some other embodiments, contacting the electrode active material with the ionically conducting solid-electrolyte can include physical absorption of the ionically conducting solid electrolyte on the electrode active material. In some embodiments, the physical absorption can include an aerosol spray, a roll to roll deposition, casting, or a lamination process.

In some embodiments, the method can further include a physical characterization step. In some embodiments, the physical characterization can be performed using microscopy, XRD, and/or Raman spectroscopy.

Also disclosed herein are batteries that can include an anode and a cathode disposed in a housing; and an electrolyte disposed between the cathode and the anode providing an ionically conductive pathway between the anode and the cathode. In some embodiments, the anode, the cathode, or any combination thereof can include an electrode active material and an ionically conducting solid-electrolyte. In some embodiments, the cathode material can include a layered structured cathode material. In some embodiments, the ionically conducting solid-electrolyte can be present in an amount effective such that the battery exhibits greater than 80% capacity retention during 1000 cycles above 4.3V. In some embodiments, the battery can further include a separator disposed between the cathode and the anode. In some embodiments, the anode can include lithium metal or graphite.

In some embodiments, the anode, the cathode, or any combination thereof can include a solid electric conductor described herein. In some embodiments, the anode, the cathode, or any combination thereof can include a solid electric conductor made by the method described herein.

Described herein is also an electronically powered or assisted device including a battery described herein. In some embodiments, the device can be fabricated as a transportation device, a computer, a telecommunications device, a camera, a radio, or a power tool.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIGS. 1A-1C is an image showing various approaches to tailor surface of NMC powder/electrode. FIG. 1A illustrates a Wet-Chemical Coating of solid electrolyte on NMC Powder approach 1. FIG. 1B illustrates a Blending of solid electrolyte/NMC powder approach 2. FIG. 1C illustrates a physical adsorption of LATP on NMC electrode approach 3.

FIG. 2 is a graph showing the cycle life of the different NMC cells at 25° C. in the voltage range from 3.0 to 4.3 V at 0.1C-rate.

FIGS. 3A-3E are show various approaches to tailor surface of NMC powder/electrode using LATP solid electrolyte. FIG. 3A-3B show images of wet chemical coating of LATP on NMC Powder (FIG. 3A) and bare NMC powder (FIG. 3B). FIG. 3C-3D show graphs of voltage versus specific capacity for LATP treated NMC (FIG. 3C) and base NMC (FIG. 3D).

FIG. 3E shows a graph of discharge capacity versus cycle number for physical adsorption of LATP on NMC electrode.

FIG. 4A-4B are cross-sectional SEM images of the pristine NMC (FIG. 4A) and Li_{6.75}La₃Zr_{1.75}Ta_{0.25}O₁₂ (LLZT)-coated NMC (FIG. 4B) electrodes.

FIG. 5 are images showing SEM EDS shows uniform distribution of solid electrolyte.

FIG. 6 is an image showing the cycle life of pristine NMC622 and LLZT-mixed NMC622 cathodes at high voltage (up to 4.5V).

FIGS. 7A-7B are SEM images of the cycled NMC (FIG. 7A) and LLZT-mixed NMC (FIG. 7B) electrodes.

FIGS. 8A-8B are the graphs showing the electrochemical impedance spectra of the NMC (FIG. 8A) and LLZT-mixed NMC (FIG. 8B) electrodes as increasing cycle number.

FIG. 9 is a graph showing the rate-capability tests for the pristine and LLZT-mixed NMC electrodes with different currents at 25° C. in the voltage range from 3.0 to 4.5 V.

FIG. 10 is an image showing the cycle retention of the pristine and LATP-mixed NMC electrode at high voltage (up to 4.5V).

FIG. 11 is a graph showing the rate-capabilities of the pristine and LLZT-mixed LNMO electrodes in the voltage range from 3.5 to 5.0V.

FIG. 12 is a graph showing the rate-capability tests for the pristine and LLZT-mixed graphite electrodes with different currents at 25° C. in the voltage range from 0.05 to 2.0 V.

FIG. 13 is a graph showing cycle retention of the pristine and LATP-mixed NMC cathodes pairing with graphite anodes in pouch type cells electrodes.

FIGS. 14A-14C (14A) show charge and discharge curves of bare NMC cathodes using (i) normal electrolyte and (ii) moisture-contaminated electrolyte. (14B) Charge and discharge curves of 5 wt % LLZT-NMC cathodes using (i) normal electrolyte and (ii) moisture-contaminated electrolyte. (14C) Cycling life of bare NMC and 5 wt % LLZT-NMC cathodes in full-cells (pairing with graphite anodes) using moisture-contaminated electrolytes. The full-cells were cycled in a range of 2.9-4.4 V at various discharge current densities.

FIG. 15 shows XPS spectra of the surface element for cycled (i) pristine NMC and (ii) 5 wt % LLZT-NMC cathodes after cycling in moisture-contaminated electrolytes for 78 cycles in full-cells in a range of 2.9-4.4 V.

FIG. 16 shows cycle life and Coulombic efficiency of bare and LLZT mixed LNMO cathodes in a voltage range of 3.4-4.9 V using full-cells at 25° C.

FIG. 17 shows rate capabilities of bare LNMO and LLZT mixed LNMO cathodes in full-cells. The cells were discharged at various C-rates at 25° C.

FIGS. 18A-18C show Nyquist plots of (18A) 5 wt % LLZT-LNMO, (18B) bare LNMO cathodes in half-cells measured at 50% state-of-charge. (18C) Comparison of total resistance of the cells.

FIGS. 19A-19B show voltage profiles of (18A) bare LNMO and (19B) 5 wt % LLZT mixed LNMO cathodes in full-cells (pairing with graphite anodes) using moisture-contaminated electrolytes.

Like reference symbols in the various drawings indicate like elements.

### DETAILED DESCRIPTION

A number of embodiments of the disclosure have been described. Nevertheless, it will be understood that various modifications may be made without departing from the spirit and scope of the invention.

### Definitions

To facilitate understanding of the disclosure set forth herein, a number of terms are defined below. Unless defined otherwise, all technical and scientific terms used herein generally have the same meaning as commonly understood by one of ordinary skill in the art to which this disclosure belongs.

### General Definitions

To facilitate understanding of the disclosure set forth herein, a number of terms are defined below. Unless defined otherwise, all technical and scientific terms used herein have the same meanings as commonly understood by one of skill in the art to which the disclosed invention belongs. Publications cited herein and the materials for which they are cited are specifically incorporated by reference.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Other than where noted, all numbers expressing quantities of ingredients, reaction conditions, geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Accordingly, these terms are intended to not only cover the recited element(s) or step(s), but may also include other elements or steps not expressly recited. Furthermore, as used herein, the use of the terms “a”, “an”, and “the” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. A range may be construed to include the start and the end of the range. For example, a range of 10% to 20% (i.e., range of 10%-20%) can includes 10% and also includes 20%, and includes percentages in between 10% and 20%, unless explicitly stated otherwise herein.

As used herein, the terms “may,” “optionally,” and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein.

A “control” is an alternative subject or sample used in an experiment for comparison purposes. A control can be “positive” or “negative.”

Reference will now be made in detail to specific aspects of the disclosed materials, compounds, compositions, articles, and methods, examples of which are illustrated in the accompanying Examples and Figures.

### Conductors

Described herein is a solid electric conductor including two discrete populations of particles intermixed. The first population of particles can include an ionically conducting solid-electrolyte, and the second population of particles includes an electrode active material.

In some embodiments, the ionically conducting solid-electrolyte can include at least one of the following compounds a) through g):
a) LiPON (lithium phosphorus oxynitride or Li₃PO₄ (lithium phosphate);
b) garnets of general formula Li_{y}A₃B₂O₁₂ in a predominantly cubic crystal structure, where A is selected from at least one element of the group La, K, Mg, Ca, Sr, and Ba, B is selected from at least one element of the group Zr, Hf, Nb, Ta, W, In, Sn, Sb, Bi, and Te, and 3<y<7. A predominantly cubic crystal structure is a crystal structure for which at least 80 vol % is made up of a cubic crystal structure. Particularly preferred are garnets of formula Li_{y}A₃B₂O₁₂, where A=La, and B is selected from Zr, Nb, Ta, and Te. One preferred specific embodiment is garnets of general formula Li₇₋ₓLa₃Zr₂₋ₓMₓO₁₂, where M stands for Nb, Ta, or a mixture of the two elements, and 2≥x≥0, in particular 1.5≥x≥0.5, or 1.5≥x≥0.2 (LLZT). Another preferred specific embodiment is garnets of general formula Li_{7-3z}Al_{z}La₃Zr₂₋ₓMₓO₁₂, where M stands for Nb, Ta, or a mixture of the two elements, 2≥x≥0, in particular 1.5≥x≥0.5 and 0<z<0.3;
c) perovskites of general formula Li₃ₓLa_{2/3-x}TiO₃, where 2/3≥x≥0, in particular 0.5≥x≥0.2;
d) compounds of the NASICON type, represented by general formula Li₁₊ₓRₓM₂₋ₓ(PO₄)₃, where M is selected from at least one element of the group Ti, Ge, and Hf, R is selected from at least one element of the group Al, B, Sn, and Ge, and 0≤x<2. In one specific embodiment x=0. In one preferred specific embodiment M=Ti. One preferred specific embodiment is a compound of general formula Li₁₊ₓAlₓGe_{y}Ti_{2-x-y}(PO₄)₃ (LAGP or LATP), where 0≤x<2, 0≤y<2, and 0≤x+y<2; it is particularly preferred that 0≤x<1, 0≤y<1, and 0≤x+y<2;
e) Lithium-ion-conducting sulfide glasses of general formula x(Li₂S)·y(P₂S₃)·z(MₙSₘ), where MₙSₘ has the meaning SnS₂, GeS₂, B₂S₃, or SiS₂, and x, y, and z may each independently assume a value of 0 to 100, with the condition that x+y+z=100. One preferred specific embodiment is sulfidic glasses where 60≤x≤90, 30≤y≤60, and z=0. It is particularly preferred that x=70, y=30, and z=0. Further preferred specific embodiments are sulfidic glasses having the composition x (Li₂S)·(P₂S₅)·z(GeS₂), where y=z=14 and x=72;
f) argyrodites of formula Li₆PS₅X, where X may be selected from Cl, Br, and I; preferred specific embodiments are Li₆PS₅Cl and Li₆GPS₅Br; Li₆PS₅Cl is particularly preferred; and/or
g) polymer electrolytes based on polyethylene oxide (PEO); for increasing the lithium ion conductivity, the polymer electrolytes preferably include lithium salts selected from lithium hexafluorophosphate (LiPF₆), lithium tetrafluoroborate (LiBF₄), LiSbF₆, LiAsF₆, Li(CF₃)SO₂NSO₂(CF₃) (LiTFSI), LiClO₄, lithium bis(oxalato)borate (Li[B(C₂O₄)₂], LiBOB), and/or lithium difluoro(oxalato)borate (Li[BF₂(C₂O₄)], LiDFOB).

In some embodiments, the ionically conducing solid-electrolyte can include Li₇La₃Zr₂O₁₂ (LLZO), Li_{1.4}Al_{0.4}Ti_{1.6}(PO₄)₃ (LATP), Li_{0.5}La_{0.5}TiO₃ (LLTO), Li₃PO₄, Li₂HPO₄, Li_{6.75}La₃Zr_{1.75}Ta_{0.25}O₁₂ (LLZT), or any combination thereof.

In some embodiments, the ionically conducing solid-electrolyte can include Li₇La₃Zr₂O₁₂ (LLZO), Li_{1.4}Al_{0.4}Ti_{1.6}(PO₄)₃ (LATP), Li_{0.5}La_{0.5}TiO₃ (LLTO), Li₃PO₄, Li₂HPO₄, or Li_{6.75}La₃Zr_{1.75}Ta_{0.25}O₁₂ (LLZT).

In some embodiments, the electrode active material can include an anode material, a cathode material, or any combination thereof. In some embodiments, the electrode active material can include an anode material. In some embodiments, the electrode active material can include a cathode material. In some embodiments, the electrode active material can include an anode material and a cathode material.

In some examples, the electrode active material can include layered-structured cathode materials such as LiNi_{0.6}Mn_{0.2}Co_{0.2}O₂ (NMC622), LiNi_{0.8}Co_{0.1}Mn_{0.1}O₂ (NMC811), LiNi_{1/3}Mn_{1/3}Co_{1/3}O₂ (NMC111), LiNi_{0.5}Mn_{1.5}O₄ (LNMO), LiNi_{0.5}Mn_{1.5-x}TiₓO₄, or LiNi_{0.8}Co_{0.15}Al_{0.05}O₂ (NCA), or the like; cubic spinel cathode materials such as LiM₂O₄ (where M=Mn, Co, Ni, Al, Ti, Mg, combination thereof and the like); olivine materials such as LiMPO₄ (where M=Fe, Co, Mn, combination thereof and the like); or any combination thereof.

In some embodiments, the electrode active material can include LiNi_{0.6}Mn_{0.2}Co_{0.2}O₂ (NMC622), LiNi_{0.8}Co_{0.1}Mn_{0.1}O₂ (NMC811), LiNi_{1/3}Mn_{1/3}Co_{1/3}O₂ (NMC111), LiNi_{0.5}Mn_{1.5}O₄ (LNMO), LiNi_{0.5}Mn_{1.5-x}TiₓO₄, LiNi_{0.8}Co_{0.15}Al_{0.05}O₂ (NCA), or any combination thereof.

In some embodiments, the electrode active material can include LiNi_{0.6}Mn_{0.2}Co_{0.2}O₂ (NMC622), LiNi_{0.8}Co_{0.1}Mn_{0.1}O₂ (NMC811), LiNi_{1/3}Mn_{1/3}Co_{1/3}O₂ (NMC111), LiNi_{0.5}Mn_{1.5}O₄ (LNMO), LiNi_{0.5}Mn_{1.5-x}TiₓO₄, or LiNi_{0.8}Co_{0.15}Al_{0.05}O₂ (NCA).

In some embodiments, the electrode active material can be manganese rich. In some embodiments, the electrode active material can be represented by formula I:

Li_{1+z}(Ni_{1-x-y}MnₓCo_{y})_{1-z}O₂
wherein y is less than 0.12, x is greater than 0.5, and z is 0.13. In some embodiments, the electrode active material can be Li_{1.13}Ni_{0.28125}Mn_{0.53125}Co_{0.1875}O_{2.13}.

In some embodiments, the electrode active material can be nickel rich. In some embodiments, the electrode active material can be represented by formula II:

LiNi_{1-x-y}MnₓCo_{y}O₂
wherein x is less than 0.1; and y is less than 0.1.

In some embodiments, the electrode active material can be represented by Formula III:

LiNi₁₋ₓCo_{0.5x}Mn_{0.5x}O₂
wherein x is 0.15 or 0.1.

In some embodiments, the electrode active material can be LiNi_{0.85}Co_{0.075}Mn_{0.075}O₂, LiNi_{0.9}Co_{0.05}Mn_{0.05}O₂, LiNi_{0.5}Mn_{1.5-x}TiₓO₄, LiNi_{0.8}Co_{0.15}Al_{0.05}O₂, or the like.

In some embodiments, the positive electrode active material can be represented by a formula Li_{1+b}Ni_{α}Mn_{β-δ}Co_{γ}M_{δ}O_{2-z}F_{z}, where b ranges from 0.01 to 0.3, α ranges from 0 to 0.4, β ranges from 0.2 to 0.65, γ ranges from 0 to 0.45, δ ranges from 0 to 0.15 and z ranges from 0 to 0.2, and where M can be Mg, Zn, Al, Ga, B, Zr, Ti, Ca, Ce, Y, Nb or combinations thereof.

In some embodiments, the electrode active material can further include a binder, a carbon conductive material, a passivation layer, or any combination thereof. In some embodiments, the electrode active material can further include a binder. In some embodiments, the electrode active material can further include a carbon conductive material. In some embodiments, the electrode active material can further include a passivation layer. In some embodiments, the electrode active material can further include a binder, a carbon conductive material, and a passivation layer. In some embodiments, the electrode active material can further include a binder and a carbon conductive material. In some embodiments, the electrode active material can further include a binder and a passivation layer. In some embodiments, the electrode active material can further include a carbon conductive material and a passivation layer.

In some embodiments, the first population of particles can exhibit an average particle size of from 20 nm to 30 μm (e.g., from 20 nm to 50 nm, from 20 nm to 100 nm, from 20 nm to 250 nm, from 20 nm to 500 nm, from 20 nm to 750 nm, from 20 nm to 1 μm, from 20 nm to 5 μm, from 20 nm to 10 μm, from 20 nm to 15 μm, from 20 nm to 20 μm, from 20 nm to 25 μm, from 50 nm to 100 nm, from 50 nm to 250 nm, from 50 nm to 500 nm, from 50 nm to 750 nm, from 50 nm to 1 μm, from 50 nm to 5 μm, from 50 nm to 10 μm, from 50 nm to 15 μm, from 50 nm to 20 μm, from 50 nm to 25 μm, from 50 nm to 30 μm, from 100 nm to 250 nm, from 100 nm to 500 nm, from 100 nm to 750 nm, from 100 nm to 1 μm, from 100 nm to 5 μm, from 100 nm to 10 μm, from 100 nm to 15 μm, from 100 nm to 20 μm, from 100 nm to 25 μm, from 100 nm to 30 μm, from 250 nm to 500 nm, from 250 nm to 750 nm, from 250 nm to 1 μm, from 250 nm to 5 μm, from 250 nm to 10 μm, from 250 nm to 15 μm, from 250 nm to 20 μm, from 250 nm to 25 μm, from 250 nm to 30 μm, from 500 nm to 750 nm, from 500 nm to 1 μm, from 500 nm to 5 μm, from 500 nm to 10 μm, from 500 nm to 15 μm, from 500 nm to 20 μm, from 500 nm to 25 μm, from 500 nm to 30 μm, from 1 μm to 5 μm, from 1 μm to 10 μm, from 1 μm to 15 μm, from 1 μm to 20 μm, from 1 μm to 25 μm, from 1 μm to 30 μm, from 5 μm to 10 μm, from 5 μm to 15 μm, from 5 μm to 20 μm, from 5 μm to 25 μm, from 5 μm to 30 μm, from 10 μm to 15 μm, from 10 μm to 20 μm, from 10 μm to 25 μm, from 10 μm to 30 μm, from 15 μm to 20 μm, from 15 μm to 25 μm, from 15 μm to 30 μm, from 20 μm to 25 μm, from 20 μm to 30 μm, or from 25 μm to 30 μm). In some embodiments, the second population of particles can exhibit an average particle size of from 20 nm to 30 μm (e.g., from 20 nm to 50 nm, from 20 nm to 100 nm, from 20 nm to 250 nm, from 20 nm to 500 nm, from 20 nm to 750 nm, from 20 nm to 1 μm, from 20 nm to 5 μm, from 20 nm to 10 μm, from 20 nm to 15 μm, from 20 nm to 20 μm, from 20 nm to 25 μm, from 50 nm to 100 nm, from 50 nm to 250 nm, from 50 nm to 500 nm, from 50 nm to 750 nm, from 50 nm to 1 μm, from 50 nm to 5 μm, from 50 nm to 10 μm, from 50 nm to 15 μm, from 50 nm to 20 μm, from 50 nm to 25 μm, from 50 nm to 30 μm, from 100 nm to 250 nm, from 100 nm to 500 nm, from 100 nm to 750 nm, from 100 nm to 1 μm, from 100 nm to 5 μm, from 100 nm to 10 μm, from 100 nm to 15 μm, from 100 nm to 20 μm, from 100 nm to 25 μm, from 100 nm to 30 μm, from 250 nm to 500 nm, from 250 nm to 750 nm, from 250 nm to 1 μm, from 250 nm to 5 μm, from 250 nm to 10 μm, from 250 nm to 15 μm, from 250 nm to 20 μm, from 250 nm to 25 μm, from 250 nm to 30 μm, from 500 nm to 750 nm, from 500 nm to 1 μm, from 500 nm to 5 μm, from 500 nm to 10 μm, from 500 nm to 15 μm, from 500 nm to 20 μm, from 500 nm to 25 μm, from 500 nm to 30 μm, from 1 μm to 5 μm, from 1 μm to 10 μm, from 1 μm to 15 μm, from 1 μm to 20 μm, from 1 μm to 25 μm, from 1 μm to 30 μm, from 5 μm to 10 μm, from 5 μm to 15 μm, from 5 μm to 20 μm, from 5 μm to 25 μm, from 5 μm to 30 μm, from 10 μm to 15 μm, from 10 μm to 20 μm, from 10 μm to 25 μm, from 10 μm to 30 μm, from 15 μm to 20 μm, from 15 μm to 25 μm, from 15 μm to 30 μm, from 20 μm to 25 μm, from 20 μm to 30 μm, or from 25 μm to 30 μm).

In some embodiments, the first population of particles can exhibit an average particle size and the second population of particles can exhibit an average particle size, and wherein the average particle size of the first population of particles can be from 0.005 to 200 of the average particle size of the second population of particles (e.g., from 0.005 to 150, from 0.005 to 100, from 0.005 to 50, from 0.005 to 25, from 0.005 to 10, from 0.005 to 5, from 0.005 to 1, from 0.005 to 0.5, from 0.005 to 0.1, from 0.005 to 0.05, from 0.05 to 200, from 0.05 to 150, from 0.05 to 100, from 0.05 to 50, from 0.05 to 25, from 0.05 to 10, from 0.05 to 5, from 0.05 to 1, from 0.05 to 0.5, from 0.05 to 0.1, from 0.5 to 200, from 0.5 to 150, from 0.5 to 100, from 0.5 to 50, from 0.5 to 25, from 0.5 to 10, from 0.5 to 5, from 0.5 to 1, from 1 to 200, from 1 to 150, from 1 to 100, from 1 to 50, from 1 to 25, from 1 to 10, from 1 to 5, from 5 to 200, from 5 to 150, from 5 to 100, from 5 to 50, from 5 to 25, from 5 to 10, from 10 to 200, from 10 to 150, from 10 to 100, from 10 to 50, from 10 to 25, from 25 to 200, from 25 to 150, from 25 to 100, from 25 to 50, from 50 to 200, from 50 to 150, from 50 to 100, from 100 to 150, or from 100 to 200). In some embodiments, the first population of particles, the second population of particles, or any combination thereof can have a spherical shape.

In some embodiments, the first population of particles and the second population of particles can be present in a weight ratio of from 1:1000 to 1:5 (e.g., 1:1000 to 1:750, 1:1000 to 1:500, 1:1000 to 1:250, 1:1000 to 1:200, 1:1000 to 1:150, 1:1000 to 1:100, 1:1000 to 1:50, 1:1000 to 1:25, 1:1000 to 1:10, 1:500 to 1:250, 1:500 to 1:200, 1:500 to 1:150, 1:500 to 1:100, 1:500 to 1:50, 1:500 to 1:25, 1:500 to 1:10, 1:500 to 1:5, 1:250 to 1:200, 1:250 to 1:150, 1:250 to 1:100, 1:250 to 1:50, 1:250 to 1:25, 1:250 to 1:10, 1:250 to 1:5, 1:200 to 1:150, 1:200 to 1:100, 1:200 to 1:50, 1:200 to 1:25, 1:200 to 1:10, 1:200 to 1:5, 1:100 to 1:50, 1:100 to 1:25, 1:100 to 1:10, 1:100 to 1:5, 1:50 to 1:25, 1:50 to 1:10, 1:50 to 1:5, 1:25 to 1:10, 1:25 to 1:5, or 1:10 to 1:5).

In some embodiments, the first population of particles can be physically blended with the second population of particles. In some embodiments, the first population of particles can be wet-chemically coated on the second population of particles. In some embodiments, the first population of particles can be physically absorbed by the second population of particles.

### Method of Making

Described herein are also methods of making a solid electric conductor. In some embodiments, the method can include contacting a first population of particles including an ionically conducting solid-electrolyte described herein with a second population of particles including an electrode active material described herein.

In some embodiments, the electrode active material and the ionically conducting solid-electrolyte can be in the form of a powder. In some embodiments, contacting the electrode active material with the ionically conducting solid-electrolyte can include physically blending the ionically conducting solid-electrolyte and the electrode active material. In some embodiments, physical blending can be performed by mechanical mixing or dropcast mixing.

In some other embodiments, contacting the electrode active material with the ionically conducting solid-electrolyte can include wet chemical coating the ionically conducting solid-electrolyte on the electrode active material. In some other embodiments, wet chemical coating can be performed by a sol-gel, hydrothermal, or solvothermal synthesis process.

In some other embodiments, contacting the electrode active material with the ionically conducting solid-electrolyte can include physical absorption of the ionically conducting solid electrolyte on the electrode active material. In some embodiments, physical absorption can be performed by aerosol spray, a roll to roll deposition, casting, or a lamination process.

In some embodiments, the method can further include a physical characterization step that can be performed using microscopy, XRD, Raman spectroscopy, or any combination thereof.

In some embodiments, the ionically conducting solid-electrolyte can include at least one of the following compounds a) through g):
a) LiPON (lithium phosphorus oxynitride or Li₃PO₄ (lithium phosphate);
b) garnets of general formula Li_{y}A₃B₂O₁₂ in a predominantly cubic crystal structure, where A is selected from at least one element of the group La, K, Mg, Ca, Sr, and Ba, B is selected from at least one element of the group Zr, Hf, Nb, Ta, W, In, Sn, Sb, Bi, and Te, and 3<y<7. A predominantly cubic crystal structure is a crystal structure for which at least 80 vol % is made up of a cubic crystal structure. Particularly preferred are garnets of formula Li_{y}A₃B₂O₁₂, where A=La, and B is selected from Zr, Nb, Ta, and Te. One preferred specific embodiment is garnets of general formula Li₇₋ₓLa₃Zr₂₋ₓMₓO₁₂, where M stands for Nb, Ta, or a mixture of the two elements, and 2≥x≥0, in particular 1.5≥x≥0.5, or 1.5≥x≥0.2 (LLZT). Another preferred specific embodiment is garnets of general formula Li_{7-3z}Al_{z}La₃Zr₂₋ₓMₓO₁₂, where M stands for Nb, Ta, or a mixture of the two elements, 2≥x≥0, in particular 1.5≥x≥0.5 and 0<z<0.3;
c) perovskites of general formula Li₃ₓLa_{2/3-x}TiO₃, where 2/3≥x≥0, in particular 0.5≥x≥0.2;
d) compounds of the NASICON type, represented by general formula Li₁₊ₓRₓM₂₋ₓ(PO₄)₃, where M is selected from at least one element of the group Ti, Ge, and Hf, R is selected from at least one element of the group Al, B, Sn, and Ge, and 0≤x<2. In one specific embodiment x=0. In one preferred specific embodiment M=Ti. One preferred specific embodiment is a compound of general formula Li₁₊ₓAlₓGe_{y}Ti_{2-x-y}(PO₄)₃ (LAGP or LATP), where 0≤x<2, 0≤y<2, and 0≤x+y<2; it is particularly preferred that 0≤x<1, 0≤y<1, and 0≤x+y<2;
e) Lithium-ion-conducting sulfide glasses of general formula x(Li₂S)·y(P₂S₃)·z(MₙSₘ), where MₙSₘ has the meaning SnS₂, GeS₂, B₂S₃, or SiS₂, and x, y, and z may each independently assume a value of 0 to 100, with the condition that x+y+z=100. One preferred specific embodiment is sulfidic glasses where 60≤x≤90, 30≤y≤60, and z=0. It is particularly preferred that x=70, y=30, and z=0. Further preferred specific embodiments are sulfidic glasses having the composition x (Li₂S)·(P₂S₅)·z(GeS₂), where y=z=14 and x=72;
f) argyrodites of formula Li₆PS₅X, where X may be selected from Cl, Br, and I; preferred specific embodiments are Li₆PS₅Cl and Li₆GPS₅Br; Li₆PS₅Cl is particularly preferred; and/or
g) polymer electrolytes based on polyethylene oxide (PEO); for increasing the lithium ion conductivity, the polymer electrolytes preferably include lithium salts selected from lithium hexafluorophosphate (LiPF₆), lithium tetrafluoroborate (LiBF₄), LiSbF₆, LiAsF₆, Li(CF₃)SO₂NSO₂(CF₃) (LiTFSI), LiClO₄, lithium bis(oxalato)borate (Li[B(C₂O₄)₂], LiBOB), and/or lithium difluoro(oxalato)borate (Li[BF₂(C₂O₄)], LiDFOB).

In some embodiments, the ionically conducing solid-electrolyte can include Li₇La₃Zr₂O₁₂ (LLZO), Li_{1.4}Al_{0.4}Ti_{1.6}(PO₄)₃ (LATP), Li_{0.5}La_{0.5}TiO₃ (LLTO), Li₃PO₄, Li₂HPO₄, Li_{6.75}La₃Zr_{1.75}Ta_{0.25}O₁₂ (LLZT), or any combination thereof.

In some embodiments, the ionically conducing solid-electrolyte can include Li₇La₃Zr₂O₁₂ (LLZO), Li_{1.4}Al_{0.4}Ti_{1.6}(PO₄)₃ (LATP), Li_{0.5}La_{0.5}TiO₃ (LLTO), Li₃PO₄, Li₂HPO₄, or Li_{6.75}La₃Zr_{1.75}Ta_{0.25}O₁₂ (LLZT).

In some embodiments, the electrode active material can include an anode material, a cathode material, or any combination thereof. In some embodiments, the electrode active material can include an anode material. In some embodiments, the electrode active material can include a cathode material. In some embodiments, the electrode active material can include an anode material and a cathode material.

In some examples, the electrode active material can include layered-structured cathode materials such as LiNi_{0.6}Mn_{0.2}Co_{0.2}O₂ (NMC622), LiNi_{0.8}Co_{0.1}Mn_{0.1}O₂ (NMC811), LiNi_{1/3}Mn_{1/3}Co_{1/3}O₂ (NMC111), LiNi_{0.5}Mn_{1.5}O₄ (LNMO), LiNi_{0.5}Mn_{1.5-x}TiₓO₄, or LiNi_{0.8}Co_{0.15}Al_{0.05}O₂ (NCA), or the like; cubic spinel cathode materials such as LiM₂O₄ (where M=Mn, Co, Ni, Al, Ti, Mg, combination thereof and the like); olivine materials such as LiMPO₄ (where M=Fe, Co, Mn, combination thereof and the like); or any combination thereof.

In some embodiments, the electrode active material can include LiNi_{0.6}Mn_{0.2}Co_{0.2}O₂ (NMC622), LiNi_{0.8}Co_{0.1}Mn_{0.1}O₂ (NMC811), LiNi_{1/3}Mn_{1/3}Co_{1/3}O₂ (NMC111), LiNi_{0.5}Mn_{1.5}O₄ (LNMO), LiNi_{0.5}Mn_{1.5-x}TiₓO₄, LiNi_{0.8}Co_{0.15}Al_{0.05}O₂ (NCA), or any combination thereof.

In some embodiments, the electrode active material can include LiNi_{0.6}Mn_{0.2}Co_{0.2}O₂ (NMC622), LiNi_{0.8}Co_{0.1}Mn_{0.1}O₂ (NMC811), LiNi_{1/3}Mn_{1/3}Co_{1/3}O₂ (NMC111), LiNi_{0.5}Mn_{1.5}O₄ (LNMO), LiNi_{0.5}Mn_{1.5-x}TiₓO₄, or LiNi_{0.8}Co_{0.15}Al_{0.05}O₂ (NCA).

In some embodiments, the electrode active material can be manganese rich. In some embodiments, the electrode active material can be represented by formula I:

Li_{1+z}(Ni_{1-x-y}MnₓCo_{y})_{1-z}O₂
wherein y is less than 0.12, x is greater than 0.5, and z is 0.13. In some embodiments, the electrode active material can be Li_{1.13}Ni_{0.28125}Mn_{0.53125}Co_{0.1875}O_{2.13}.

In some embodiments, the electrode active material can be nickel rich. In some embodiments, the electrode active material can be represented by formula II:

LiNi_{1-x-y}MnₓCo_{y}O₂

wherein x is less than 0.1; and y is less than 0.1.

In some embodiments, the electrode active material can be represented by Formula III:

LiNi₁₋ₓCo_{0.5x}Mn_{0.5x}O₂

wherein x is 0.15 or 0.1.

In some embodiments, the electrode active material can be LiNi_{0.85}Co_{0.075}Mn_{0.075}O₂, LiNi_{0.9}Co_{0.05}Mn_{0.05}O₂, LiNi_{0.5}Mn_{1.5-x}TiₓO₄, LiNi_{0.8}Co_{0.15}Al_{0.05}O₂, or any combination thereof.

In some embodiments, the electrode active material can be LiNi_{0.85}Co_{0.075}Mn_{0.075}O₂, LiNi_{0.9}Co_{0.05}Mn_{0.05}O₂, LiNi_{0.5}Mn_{1.5-x}TiₓO₄, or LiNi_{0.8}Co_{0.15}Al_{0.05}O₂.

In some embodiments, the positive electrode active material can be represented by a formula Li_{1+b}Ni_{α}Mn_{β-δ}Co_{γ}M_{δ}O_{2-z}F_{z}, where b ranges from 0.01 to 0.3, α ranges from 0 to 0.4, β ranges from 0.2 to 0.65, γ ranges from 0 to 0.45, δ ranges from 0 to 0.15 and z ranges from 0 to 0.2, and where M can be Mg, Zn, Al, Ga, B, Zr, Ti, Ca, Ce, Y, Nb or combinations thereof.

In some embodiments, the electrode active material can further include a binder, a carbon conductive material, a passivation layer, or any combination thereof. In some embodiments, the electrode active material can further include a binder. In some embodiments, the electrode active material can further include a carbon conductive material. In some embodiments, the electrode active material can further include a passivation layer. In some embodiments, the electrode active material can further include a binder, a carbon conductive material, and a passivation layer. In some embodiments, the electrode active material can further include a binder and a carbon conductive material. In some embodiments, the electrode active material can further include a binder and a passivation layer. In some embodiments, the electrode active material can further include a carbon conductive material and a passivation layer.

In some embodiments, the first population of particles can exhibit an average particle size of from 20 nm to 30 μm (e.g., from 20 nm to 50 nm, from 20 nm to 100 nm, from 20 nm to 250 nm, from 20 nm to 500 nm, from 20 nm to 750 nm, from 20 nm to 1 μm, from 20 nm to 5 μm, from 20 nm to 10 μm, from 20 nm to 15 μm, from 20 nm to 20 μm, from 20 nm to 25 μm, from 50 nm to 100 nm, from 50 nm to 250 nm, from 50 nm to 500 nm, from 50 nm to 750 nm, from 50 nm to 1 μm, from 50 nm to 5 μm, from 50 nm to 10 μm, from 50 nm to 15 μm, from 50 nm to 20 μm, from 50 nm to 25 μm, from 50 nm to 30 μm, from 100 nm to 250 nm, from 100 nm to 500 nm, from 100 nm to 750 nm, from 100 nm to 1 μm, from 100 nm to 5 μm, from 100 nm to 10 μm, from 100 nm to 15 μm, from 100 nm to 20 μm, from 100 nm to 25 μm, from 100 nm to 30 μm, from 250 nm to 500 nm, from 250 nm to 750 nm, from 250 nm to 1 μm, from 250 nm to 5 μm, from 250 nm to 10 μm, from 250 nm to 15 μm, from 250 nm to 20 μm, from 250 nm to 25 μm, from 250 nm to 30 μm, from 500 nm to 750 nm, from 500 nm to 1 μm, from 500 nm to 5 μm, from 500 nm to 10 μm, from 500 nm to 15 μm, from 500 nm to 20 μm, from 500 nm to 25 μm, from 500 nm to 30 μm, from 1 μm to 5 μm, from 1 μm to 10 μm, from 1 μm to 15 μm, from 1 μm to 20 μm, from 1 μm to 25 μm, from 1 μm to 30 μm, from 5 μm to 10 μm, from 5 μm to 15 μm, from 5 μm to 20 μm, from 5 μm to 25 μm, from 5 μm to 30 μm, from 10 μm to 15 μm, from 10 μm to 20 μm, from 10 μm to 25 μm, from 10 μm to 30 μm, from 15 μm to 20 μm, from 15 μm to 25 μm, from 15 μm to 30 μm, from 20 μm to 25 μm, from 20 μm to 30 μm, or from 25 μm to 30 μm).

In some embodiments, the second population of particles can exhibit an average particle size of from 20 nm to 30 μm (e.g., from 20 nm to 50 nm, from 20 nm to 100 nm, from 20 nm to 250 nm, from 20 nm to 500 nm, from 20 nm to 750 nm, from 20 nm to 1 μm, from 20 nm to 5 μm, from 20 nm to 10 μm, from 20 nm to 15 μm, from 20 nm to 20 μm, from 20 nm to 25 μm, from 50 nm to 100 nm, from 50 nm to 250 nm, from 50 nm to 500 nm, from 50 nm to 750 nm, from 50 nm to 1 μm, from 50 nm to 5 μm, from 50 nm to 10 μm, from 50 nm to 15 μm, from 50 nm to 20 μm, from 50 nm to 25 μm, from 50 nm to 30 μm, from 100 nm to 250 nm, from 100 nm to 500 nm, from 100 nm to 750 nm, from 100 nm to 1 μm, from 100 nm to 5 μm, from 100 nm to 10 μm, from 100 nm to 15 μm, from 100 nm to 20 μm, from 100 nm to 25 μm, from 100 nm to 30 μm, from 250 nm to 500 nm, from 250 nm to 750 nm, from 250 nm to 1 μm, from 250 nm to 5 μm, from 250 nm to 10 μm, from 250 nm to 15 μm, from 250 nm to 20 μm, from 250 nm to 25 μm, from 250 nm to 30 μm, from 500 nm to 750 nm, from 500 nm to 1 μm, from 500 nm to 5 μm, from 500 nm to 10 μm, from 500 nm to 15 μm, from 500 nm to 20 μm, from 500 nm to 25 μm, from 500 nm to 30 μm, from 1 μm to 5 μm, from 1 μm to 10 μm, from 1 μm to 15 μm, from 1 μm to 20 μm, from 1 μm to 25 μm, from 1 μm to 30 μm, from 5 μm to 10 μm, from 5 μm to 15 μm, from 5 μm to 20 μm, from 5 μm to 25 μm, from 5 μm to 30 μm, from 10 μm to 15 μm, from 10 μm to 20 μm, from 10 μm to 25 μm, from 10 μm to 30 μm, from 15 μm to 20 μm, from 15 μm to 25 μm, from 15 μm to 30 μm, from 20 μm to 25 μm, from 20 μm to 30 μm, or from 25 μm to 30 μm).

In some embodiments, the first population of particles can exhibit an average particle size and the second population of particles exhibits an average particle size, and wherein the average particle size of the first population of particles is from 0.005 to 200 of the average particle size of the second population of particles (e.g., from 0.005 to 150, from 0.005 to 100, from 0.005 to 50, from 0.005 to 25, from 0.005 to 10, from 0.005 to 5, from 0.005 to 1, from 0.005 to 0.5, from 0.005 to 0.1, from 0.005 to 0.05, from 0.05 to 200, from 0.05 to 150, from 0.05 to 100, from 0.05 to 50, from 0.05 to 25, from 0.05 to 10, from 0.05 to 5, from 0.05 to 1, from 0.05 to 0.5, from 0.05 to 0.1, from 0.5 to 200, from 0.5 to 150, from 0.5 to 100, from 0.5 to 50, from 0.5 to 25, from 0.5 to 10, from 0.5 to 5, from 0.5 to 1, from 1 to 200, from 1 to 150, from 1 to 100, from 1 to 50, from 1 to 25, from 1 to 10, from 1 to 5, from 5 to 200, from 5 to 150, from 5 to 100, from 5 to 50, from 5 to 25, from 5 to 10, from 10 to 200, from 10 to 150, from 10 to 100, from 10 to 50, from 10 to 25, from 25 to 200, from 25 to 150, from 25 to 100, from 25 to 50, from 50 to 200, from 50 to 150, from 50 to 100, from 100 to 150, or from 100 to 200). In some embodiments, the first population of particles, the second population of particles, or any combination thereof can have a spherical shape.

In some embodiments, the first population of particles and the second population of particles can be present in a weight ratio of from 1:1000 to 1:5 (e.g., 1:1000 to 1:750, 1:1000 to 1:500, 1:1000 to 1:250, 1:1000 to 1:200, 1:1000 to 1:150, 1:1000 to 1:100, 1:1000 to 1:50, 1:1000 to 1:25, 1:1000 to 1:10, 1:500 to 1:250, 1:500 to 1:200, 1:500 to 1:150, 1:500 to 1:100, 1:500 to 1:50, 1:500 to 1:25, 1:500 to 1:10, 1:500 to 1:5, 1:250 to 1:200, 1:250 to 1:150, 1:250 to 1:100, 1:250 to 1:50, 1:250 to 1:25, 1:250 to 1:10, 1:250 to 1:5, 1:200 to 1:150, 1:200 to 1:100, 1:200 to 1:50, 1:200 to 1:25, 1:200 to 1:10, 1:200 to 1:5, 1:100 to 1:50, 1:100 to 1:25, 1:100 to 1:10, 1:100 to 1:5, 1:50 to 1:25, 1:50 to 1:10, 1:50 to 1:5, 1:25 to 1:10, 1:25 to 1:5, or 1:10 to 1:5).

### Batteries

Also disclosed herein are batteries that include an anode and a cathode disposed in a housing; and an electrolyte disposed between the cathode and the anode providing an ionically conductive pathway between the anode and the cathode. In some embodiments, the anode, the cathode, or any combination thereof can include an electrode active material and an ionically conducting solid-electrolyte. In some embodiments, the cathode material can include a layered structured cathode material. In some embodiments, the ionically conducting solid-electrolyte can be present in an effective amount such that the battery can exhibit greater than 80% capacity retention during 1000 cycles above 4.3V (e.g., greater than 85% capacity retention during 1000 cycles above 4.3V, greater than 90% capacity retention during 1000 cycles above 4.3V, greater than 95% capacity retention during 1000 cycles above 4.3V). In some embodiments, the ionically conducting solid-electrolyte can be present in an effective amount such that the battery can exhibit from greater than 80% to 98% capacity retention during 1000 cycles above 4.3V (e.g., from 85% to 98% capacity retention during 1000 cycles above 4.3V, from 90% to 98% capacity retention during 1000 cycles above 4.3V, from 95% to 98% capacity retention during 1000 cycles above 4.3V, from 85% to 90% capacity retention during 1000 cycles above 4.3V, from 85% to 95% capacity retention during 1000 cycles above 4.3V, or from 90% to 95% capacity retention during 1000 cycles above 4.3V). In some embodiments, the battery can further include a separator disposed between the cathode and the anode.

In some embodiments, the anode can include lithium metal, graphite, synthetic graphite, hard carbon, graphite coated metal foil, carbon nanotube, carbon nanofiber, or a combination thereof. In some embodiments, the anode can include lithium metal, or graphite.

In some embodiments, the anode, the cathode, or any combination thereof can include a solid electric conductor described herein. In some embodiments, the solid electric conductor can include two discrete populations of particles intermixed. The first population of particles can include an ionically conducting solid-electrolyte, and the second population of particles can include an electrode active material.

In some embodiments, the ionically conducting solid-electrolyte comprises at least one of the following compounds a) through g):
a) LiPON (lithium phosphorus oxynitride or Li₃PO₄ (lithium phosphate);
b) garnets of general formula Li_{y}A₃B₂O₁₂ in a predominantly cubic crystal structure, where A is selected from at least one element of the group La, K, Mg, Ca, Sr, and Ba, B is selected from at least one element of the group Zr, Hf, Nb, Ta, W, In, Sn, Sb, Bi, and Te, and 3<y<7. A predominantly cubic crystal structure is a crystal structure for which at least 80 vol % is made up of a cubic crystal structure. Particularly preferred are garnets of formula Li_{y}A₃B₂O₁₂, where A=La, and B is selected from Zr, Nb, Ta, and Te. One preferred specific embodiment is garnets of general formula Li₇₋ₓLa₃Zr₂₋ₓMₓO₁₂, where M stands for Nb, Ta, or a mixture of the two elements, and 2≥x≥0, in particular 1.5≥x≥0.5, or 1.5≥x≥0.2 (LLZT). Another preferred specific embodiment is garnets of general formula Li_{7-3z}Al_{z}La₃Zr₂₋ₓMₓO₁₂, where M stands for Nb, Ta, or a mixture of the two elements, 2≥x≥0, in particular 1.5≥x≥0.5 and 0<z<0.3;
c) perovskites of general formula Li₃ₓLa_{2/3-x}TiO₃, where 2/3≥x≥0, in particular 0.5≥x≥0.2;
d) compounds of the NASICON type, represented by general formula Li₁₊ₓRₓM₂₋ₓ(PO₄)₃, where M is selected from at least one element of the group Ti, Ge, and Hf, R is selected from at least one element of the group Al, B, Sn, and Ge, and 0≤x<2. In one specific embodiment x=0. In one preferred specific embodiment M=Ti. One preferred specific embodiment is a compound of general formula Li₁₊ₓAlₓGe_{y}Ti_{2-x-y}(PO₄)₃ (LAGP or LATP), where 0≤x<2, 0≤y<2, and 0≤x+y<2; it is particularly preferred that 0≤x<1, 0≤y<1, and 0≤x+y<2;
e) Lithium-ion-conducting sulfide glasses of general formula x(Li₂S)·y(P₂S₃)·z(MₙSₘ), where MₙSₘ has the meaning SnS₂, GeS₂, B₂S₃, or SiS₂, and x, y, and z may each independently assume a value of 0 to 100, with the condition that x+y+z=100. One preferred specific embodiment is sulfidic glasses where 60≤x≤90, 30≤y≤60, and z=0. It is particularly preferred that x=70, y=30, and z=0. Further preferred specific embodiments are sulfidic glasses having the composition x (Li₂S)·(P₂S₅)·z(GeS₂), where y=z=14 and x=72;
f) argyrodites of formula Li₆PS₅X, where X may be selected from Cl, Br, and I; preferred specific embodiments are Li₆PS₅Cl and Li₆GPS₅Br; Li₆PS₅Cl is particularly preferred; and/or
g) polymer electrolytes based on polyethylene oxide (PEO); for increasing the lithium ion conductivity, the polymer electrolytes preferably include lithium salts selected from lithium hexafluorophosphate (LiPF₆), lithium tetrafluoroborate (LiBF₄), LiSbF₆, LiAsF₆, Li(CF₃)SO₂NSO₂(CF₃) (LiTFSI), LiClO₄, lithium bis(oxalato)borate (Li[B(C₂O₄)₂], LiBOB), and/or lithium difluoro(oxalato)borate (Li[BF₂(C₂O₄)], LiDFOB).

In some embodiments, the ionically conducing solid-electrolyte can include Li₇La₃Zr₂O₁₂ (LLZO), Li_{1.4}Al_{0.4}Ti_{1.6}(PO₄)₃ (LATP), Li_{0.5}La_{0.5}TiO₃ (LLTO), Li₃PO₄, Li₂HPO₄, Li_{6.75}La₃Zr_{1.75}Ta_{0.25}O₁₂ (LLZT), or any combination thereof.

In some embodiments, the ionically conducing solid-electrolyte can include Li₇La₃Zr₂O₁₂ (LLZO), Li_{1.4}Al_{0.4}Ti_{1.6}(PO₄)₃ (LATP), Li_{0.5}La_{0.5}TiO₃ (LLTO), Li₃PO₄, Li₂HPO₄, or Li_{6.75}La₃Zr_{1.75}Ta_{0.25}O₁₂ (LLZT).

In some embodiments, the electrode active material can include an anode material, a cathode material, or any combination thereof. In some embodiments, the electrode active material can include an anode material. In some embodiments, the electrode active material can include a cathode material. In some embodiments, the electrode active material can include an anode material and a cathode material.

In some examples, the electrode active material can include layered-structured cathode materials such as LiNi_{0.6}Mn_{0.2}Co_{0.2}O₂ (NMC622), LiNi_{0.8}Co_{0.1}Mn_{0.1}O₂ (NMC811), LiNi_{1/3}Mn_{1/3}Co_{1/3}O₂ (NMC111), LiNi_{0.5}Mn_{1.5}O₄ (LNMO), LiNi_{0.5}Mn_{1.5-x}TiₓO₄, or LiNi_{0.8}Co_{0.15}Al_{0.05}O₂ (NCA), or the like; cubic spinel cathode materials such as LiM₂O₄ (where M=Mn, Co, Ni, Al, Ti, Mg, combination thereof and the like); olivine materials such as LiMPO₄ (where M=Fe, Co, Mn, combination thereof and the like); or any combination thereof.

In some embodiments, the electrode active material can include LiNi_{0.6}Mn_{0.2}Co_{0.2}O₂ (NMC622), LiNi_{0.8}Co_{0.1}Mn_{0.1}O₂ (NMC811), LiNi_{1/3}Mn_{1/3}Co_{1/3}O₂ (NMC111), LiNi_{0.5}Mn_{1.5}O₄ (LNMO), LiNi_{0.5}Mn_{1.5-x}TiₓO₄, LiNi_{0.8}Co_{0.15}Al_{0.05}O₂ (NCA), or any combination thereof.

In some embodiments, the electrode active material can include LiNi_{0.6}Mn_{0.2}Co_{0.2}O₂ (NMC622), LiNi_{0.8}Co_{0.1}Mn_{0.1}O₂ (NMC811), LiNi_{1/3}Mn_{1/3}Co_{1/3}O₂ (NMC111), LiNi_{0.5}Mn_{1.5}O₄ (LNMO), LiNi_{0.5}Mn_{1.5-x}TiₓO₄, or LiNi_{0.8}Co_{0.15}Al_{0.05}O₂ (NCA).

In some embodiments, the electrode active material can be manganese rich. In some embodiments, the electrode active material can be represented by formula I:

Li_{1+z}(Ni_{1-x-y}MnₓCo_{y})_{1-z}O₂
wherein y is less than 0.12, x is greater than 0.5, and z is 0.13. In some embodiments, the electrode active material can be Li_{1.13}Ni_{0.28125}Mn_{0.53125}Co_{0.1875}O_{2.13}.

In some embodiments, the electrode active material can be nickel rich. In some embodiments, the electrode active material can be represented by formula II:

LiNi_{1-x-y}MnₓCo_{y}O₂

wherein x is less than 0.1; and y is less than 0.1.

In some embodiments, the electrode active material can be represented by Formula III:

LiNi₁₋ₓCo_{0.5x}Mn_{0.5x}O₂

wherein x is 0.15 or 0.1.

In some embodiments, the electrode active material can be LiNi_{0.85}Co_{0.075}Mn_{0.075}O₂, LiNi_{0.9}Co_{0.05}Mn_{0.05}O₂, or LiNi_{0.5}Mn_{1.5-x}TiₓO₄, LiNi_{0.8}Co_{0.15}Al_{0.05}O₂, or any combination thereof.

In some embodiments, the electrode active material can be LiNi_{0.85}Co_{0.075}Mn_{0.075}O₂, LiNi_{0.9}Co_{0.05}Mn_{0.05}O₂, LiNi_{0.5}Mn_{1.5-x}TiₓO₄, or LiNi_{0.8}Co_{0.15}Al_{0.05}O₂.

In some embodiments, the positive electrode active material can be represented by a formula Li_{1+b}Ni_{α}Mn_{β-δ}Co_{γ}M_{δ}O_{2-z}F_{z}, where b ranges from 0.01 to 0.3, α ranges from 0 to 0.4, β ranges from 0.2 to 0.65, γ ranges from 0 to 0.45, δ ranges from 0 to 0.15 and z ranges from 0 to 0.2, and where M can be Mg, Zn, Al, Ga, B, Zr, Ti, Ca, Ce, Y, Nb or combinations thereof.

In some embodiments, the electrode active material can further include a binder, a carbon conductive material, a passivation layer, or any combination thereof. In some embodiments, the electrode active material can further include a binder. In some embodiments, the electrode active material can further include a carbon conductive material. In some embodiments, the electrode active material can further include a passivation layer. In some embodiments, the electrode active material can further include a binder, a carbon conductive material, and a passivation layer. In some embodiments, the electrode active material can further include a binder and a carbon conductive material. In some embodiments, the electrode active material can further include a binder and a passivation layer. In some embodiments, the electrode active material can further include a carbon conductive material and a passivation layer.

In some embodiments, the first population of particles can exhibit an average particle size of from 20 nm to 30 μm (e.g., from 20 nm to 50 nm, from 20 nm to 100 nm, from 20 nm to 250 nm, from 20 nm to 500 nm, from 20 nm to 750 nm, from 20 nm to 1 μm, from 20 nm to 5 μm, from 20 nm to 10 μm, from 20 nm to 15 μm, from 20 nm to 20 μm, from 20 nm to 25 μm, from 50 nm to 100 nm, from 50 nm to 250 nm, from 50 nm to 500 nm, from 50 nm to 750 nm, from 50 nm to 1 μm, from 50 nm to 5 μm, from 50 nm to 10 μm, from 50 nm to 15 μm, from 50 nm to 20 μm, from 50 nm to 25 μm, from 50 nm to 30 μm, from 100 nm to 250 nm, from 100 nm to 500 nm, from 100 nm to 750 nm, from 100 nm to 1 μm, from 100 nm to 5 μm, from 100 nm to 10 μm, from 100 nm to 15 μm, from 100 nm to 20 μm, from 100 nm to 25 μm, from 100 nm to 30 μm, from 250 nm to 500 nm, from 250 nm to 750 nm, from 250 nm to 1 μm, from 250 nm to 5 μm, from 250 nm to 10 μm, from 250 nm to 15 μm, from 250 nm to 20 μm, from 250 nm to 25 μm, from 250 nm to 30 μm, from 500 nm to 750 nm, from 500 nm to 1 μm, from 500 nm to 5 μm, from 500 nm to 10 μm, from 500 nm to 15 μm, from 500 nm to 20 μm, from 500 nm to 25 μm, from 500 nm to 30 μm, from 1 μm to 5 μm, from 1 μm to 10 μm, from 1 μm to 15 μm, from 1 μm to 20 μm, from 1 μm to 25 μm, from 1 μm to 30 μm, from 5 μm to 10 μm, from 5 μm to 15 μm, from 5 μm to 20 μm, from 5 μm to 25 μm, from 5 μm to 30 μm, from 10 μm to 15 μm, from 10 μm to 20 μm, from 10 μm to 25 μm, from 10 μm to 30 μm, from 15 μm to 20 μm, from 15 μm to 25 μm, from 15 μm to 30 μm, from 20 μm to 25 μm, from 20 μm to 30 μm, or from 25 μm to 30 μm).

In some embodiments, the second population of particles can exhibit an average particle size of from 20 nm to 30 μm (e.g., from 20 nm to 50 nm, from 20 nm to 100 nm, from 20 nm to 250 nm, from 20 nm to 500 nm, from 20 nm to 750 nm, from 20 nm to 1 μm, from 20 nm to 5 μm, from 20 nm to 10 μm, from 20 nm to 15 μm, from 20 nm to 20 μm, from 20 nm to 25 μm, from 50 nm to 100 nm, from 50 nm to 250 nm, from 50 nm to 500 nm, from 50 nm to 750 nm, from 50 nm to 1 μm, from 50 nm to 5 μm, from 50 nm to 10 μm, from 50 nm to 15 μm, from 50 nm to 20 μm, from 50 nm to 25 μm, from 50 nm to 30 μm, from 100 nm to 250 nm, from 100 nm to 500 nm, from 100 nm to 750 nm, from 100 nm to 1 μm, from 100 nm to 5 μm, from 100 nm to 10 μm, from 100 nm to 15 μm, from 100 nm to 20 μm, from 100 nm to 25 μm, from 100 nm to 30 μm, from 250 nm to 500 nm, from 250 nm to 750 nm, from 250 nm to 1 μm, from 250 nm to 5 μm, from 250 nm to 10 μm, from 250 nm to 15 μm, from 250 nm to 20 μm, from 250 nm to 25 μm, from 250 nm to 30 μm, from 500 nm to 750 nm, from 500 nm to 1 μm, from 500 nm to 5 μm, from 500 nm to 10 μm, from 500 nm to 15 μm, from 500 nm to 20 μm, from 500 nm to 25 μm, from 500 nm to 30 μm, from 1 μm to 5 μm, from 1 μm to 10 μm, from 1 μm to 15 μm, from 1 μm to 20 μm, from 1 μm to 25 μm, from 1 μm to 30 μm, from 5 μm to 10 μm, from 5 μm to 15 μm, from 5 μm to 20 μm, from 5 μm to 25 μm, from 5 μm to 30 μm, from 10 μm to 15 μm, from 10 μm to 20 μm, from 10 μm to 25 μm, from 10 μm to 30 μm, from 15 μm to 20 μm, from 15 μm to 25 μm, from 15 μm to 30 μm, from 20 μm to 25 μm, from 20 μm to 30 μm, or from 25 μm to 30 μm).

In some embodiments, the first population of particles can exhibit an average particle size and the second population of particles exhibits an average particle size, and wherein the average particle size of the first population of particles is from 0.005 to 200 of the average particle size of the second population of particles (e.g., from 0.005 to 150, from 0.005 to 100, from 0.005 to 50, from 0.005 to 25, from 0.005 to 10, from 0.005 to 5, from 0.005 to 1, from 0.005 to 0.5, from 0.005 to 0.1, from 0.005 to 0.05, from 0.05 to 200, from 0.05 to 150, from 0.05 to 100, from 0.05 to 50, from 0.05 to 25, from 0.05 to 10, from 0.05 to 5, from 0.05 to 1, from 0.05 to 0.5, from 0.05 to 0.1, from 0.5 to 200, from 0.5 to 150, from 0.5 to 100, from 0.5 to 50, from 0.5 to 25, from 0.5 to 10, from 0.5 to 5, from 0.5 to 1, from 1 to 200, from 1 to 150, from 1 to 100, from 1 to 50, from 1 to 25, from 1 to 10, from 1 to 5, from 5 to 200, from 5 to 150, from 5 to 100, from 5 to 50, from 5 to 25, from 5 to 10, from 10 to 200, from 10 to 150, from 10 to 100, from 10 to 50, from 10 to 25, from 25 to 200, from 25 to 150, from 25 to 100, from 25 to 50, from 50 to 200, from 50 to 150, from 50 to 100, from 100 to 150, or from 100 to 200). In some embodiments, the first population of particles, the second population of particles, or any combination thereof can have a spherical shape.

In some embodiments, the first population of particles and the second population of particles can be present in a weight ratio of from 1:1000 to 1:5 (e.g., 1:1000 to 1:750, 1:1000 to 1:500, 1:1000 to 1:250, 1:1000 to 1:200, 1:1000 to 1:150, 1:1000 to 1:100, 1:1000 to 1:50, 1:1000 to 1:25, 1:1000 to 1:10, 1:500 to 1:250, 1:500 to 1:200, 1:500 to 1:150, 1:500 to 1:100, 1:500 to 1:50, 1:500 to 1:25, 1:500 to 1:10, 1:500 to 1:5, 1:250 to 1:200, 1:250 to 1:150, 1:250 to 1:100, 1:250 to 1:50, 1:250 to 1:25, 1:250 to 1:10, 1:250 to 1:5, 1:200 to 1:150, 1:200 to 1:100, 1:200 to 1:50, 1:200 to 1:25, 1:200 to 1:10, 1:200 to 1:5, 1:100 to 1:50, 1:100 to 1:25, 1:100 to 1:10, 1:100 to 1:5, 1:50 to 1:25, 1:50 to 1:10, 1:50 to 1:5, 1:25 to 1:10, 1:25 to 1:5, or 1:10 to 1:5).

In some embodiments, the anode, the cathode, or any combination thereof can include a solid electric conductor made by the methods described herein. In some embodiments, the method can include contacting a first population of particles including an ionically conducting solid-electrolyte described herein with a second population of particles including an electrode active material described herein.

In some embodiments, the electrode active material and the ionically conducting solid-electrolyte can be in the form of a powder. In some embodiments, contacting the electrode active material with the ionically conducting solid-electrolyte can include physically blending the ionically conducting solid-electrolyte and the electrode active material. In some embodiments, physical blending can be performed by mechanical mixing or dropcast mixing.

In some other embodiments, contacting the electrode active material with the ionically conducting solid-electrolyte can include wet chemical coating the ionically conducting solid-electrolyte on the electrode active material. In some other embodiments, wet chemical coating can be performed by a sol-gel, hydrothermal, or solvothermal synthesis process.

In some other embodiments, contacting the electrode active material with the ionically conducting solid-electrolyte can include physical absorption of the ionically conducting solid electrolyte on the electrode active material. In some embodiments, physical absorption can be performed by aerosol spray, a roll to roll deposition, casting, or a lamination process.

In some embodiments, the method can further include a physical characterization step that can be performed using microscopy, XRD, Raman spectroscopy, or any combination thereof.

The batteries described herein can be incorporated in a variety of electronically powered or assisted devices, including transportation devices (e.g., electronic vehicles), computers, telecommunications devices (e.g., cell phones), cameras, radios, power tools, etc. The batteries can also be used in other energy storage applications.

### Examples

Cathode surface was tailored by ceramic-based solid electrolytes with high Li-ion conductivities. The data and literature demonstrate that coating with solid electrolytes (1) effectively protects the surface of cathodes at high-voltages and (2) facilitate the charge-transfer kinetics, which leads to improved cycle life, energy, and power density of Li-ion batteries.

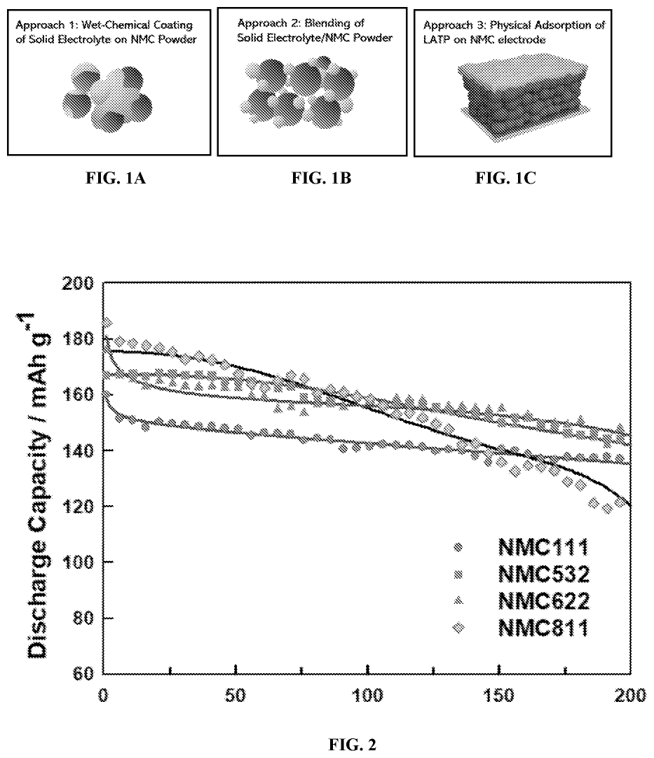

Different methods of tailoring the surface of NMC cathodes were examined: (1) wet-chemical (e.g. sol-gel) solid-electrolytes coating on NMC powder, (2) physical blending of solid-electrolyte on NMC powder, and (3) physical adsorption of solid-electrolyte on NMC electrode. Each approach can provide unique microstructure and electrochemical properties. FIG. 1A to FIG. 1C shows the schematic image of the different methods, respectively.

FIG. 2 shows the general cycle abilities of different NMC without any treatment. The NMC cathode material has been successfully commercialized for EVs attributed to their stable battery performances. However, higher Ni-contents materials (>80% of transition metals) and Mn-rich cathode materials have not been implemented in commercial batteries due to their lack of performance stability (e.g., cycle life in particular). Current R&D has invested significant efforts on stabilizing the performance of Ni-rich NMC and Mn-rich NMC cathode materials for high-energy EV batteries but is still waiting a breakthrough.

### Layered Oxides

One promising approach to reduce the cobalt loading, and also to increase the specific capacity to greater than 200 mAh/g is to increase the nickel loading, e.g., nickel-rich LiNi₁₋ₓCo_{x/2}Mn_{x/2}O₂ (NMC with 0.1≤x≤0.2). Another approach is to raise the operating voltage window to beyond 4.5V Both approaches degrade battery life and battery safety, presenting new challenges that need to be addressed. Although Ni-rich NMC has attracted great interest for electric vehicles due to its high specific energy compared with standard NMC, its adoption has been challenged by its poor cycle life and cell impedance.

Recently it has been revealed that the intrinsic instability of Ni⁴⁺ ions, present at high state-of-charge (SOC) of Ni-rich NMC, causes severe problems at cathode/liquid-electrolyte interface including electrolyte oxidation and structure decomposition from layered to rock-salt phases at the cathode surfaces. Coating the surface of Ni-rich NMC has been considered as a promising approach, but it only provides a marginal improvement because the applied coating layers usually impede Li-ion transportation that exacerbates with increasing coating thickness.

Mn-rich NMC electrodes remain attractive as a next generation cathode option because of their potential advantages in high energy, low cost, and better safety. Significant advances in Mn-rich NMC cathodes have been made over the past decade from the discovery that extra lithium content in layered transition metal oxides, Li[LiₓNi_{y}Co_{z}Mn_{1-x-y-z}]O₂ can stabilize layered structure of Mn-rich NMC composition improving specific capacity (e.g., >250 mAh/g) as well.¹ This compound can be represented in alternative notation as xLi₂MnO₃·(1−x)LiMnO₂, highlighting the concept that Li₂MnO₃ component can provide structural and electrochemical stability to the LiMnO₂ component within an integration arrangement of two structurally-compatible layered components. Despite its promising specific capacity, the Mn-rich NMC cathode suffers from poor cycle life which is strongly correlated with unfavorable reactions occurring at the cathode/electrolyte interface. For example, unprotected surface of Mn-rich NMC particles are vulnerable for excessive oxygen release at the high SOC, and the high oxygen vacancy concentration at the surface region gradually transforms to rock-salt structure via vacancy-assisted transition metal migration. The surface rock-salt region could increase the cell impedance to a significant level. In addition, Mn dissolution problem, which is one of the main reasons for poor cycle life of Mn-rich NMC full cells, should be addressed by a smart surface protection strategy.

### Surface Passivation of NMC

The cycle life issue of NMC layered cathode has been closely related to the parasitic reactions at cathode/electrolyte interface and consequent surficial degradation of cathode particles. To mitigate these issues, surface coating has been the most widely accepted approach by using various binary oxides, fluorides, and phosphates as the coting agents. However, these approaches would not be effective enough to solve the severe parasitic reactions of Ni-rich NMC and Mn-rich NMC oxides. It is partly because thickness (or amount) of coating is limited due to poor Li-ion conducting properties of the coating agents.

In general, conventional coating approaches tend to improve cycle life and thermal stability. Although different improvement mechanisms have been proposed, the effect of coated layer on complex interfacial reactions at cathode surfaces are not fully understood. Among them, the following two are the most representative mechanisms: (1) physical barrier that prevents electrochemical reactions between cathode and electrolyte in cells (or moisture in air) and (2) scavenging agent that sacrificially react with HF in electrolyte and protect cathode.

In various coating materials, Al₂O₃ has been one of the most promising coating agents for cathode, partly because of its ability to transform into a Li-ion conducting phase-amorphous LiAlO₂. The Li-ion conductivity of amorphous LiAlO₂ was determined to be 5.6×10⁻⁸ S/cm (at room-temperature).⁸ The ionic conductivity is not high enough and could cause increasing cell impedance with coating thickness.^{9,10} In addition, if Al₂O₃ is consumed through the scavenging mechanism to transform AlF₃, which is more insulating, the cell impedance will grow further.

To overcome the barriers, we tailored the surface of Ni-rich and Mn-rich NMC by ceramic-based solid-electrolyte materials with high Li-ion conductivities. The data and literature demonstrate that coating the solid electrolytes (1) effectively protect the surface of cathodes at high-voltages and (2) facilitate the charge-transfer kinetics, which leads to an improved cycle life, energy, and power density of Li-ion batteries, as will be demonstrate below.

As discussed above, both Mn-rich NMC and Ni-rich NMC have intrinsic instability in contact with battery electrolyte solution despite their advantage of low Co-content in their compositions. In materials development point of view, it will be more efficient to combined R&D efforts in developing high-energy cathode materials and their surface passivation simultaneously.

In this regard, our approach develops low-Co Ni-rich NMC and Mn-rich NMC materials and tailors the material surfaces by using Li-ion conducting solid-electrolyte materials. In addition to their excellent Li-ion transport properties at cathode-electrolyte interfaces, solid-electrolyte materials are chemically more stable than conventional coating materials. For example, it has been reported that binary oxides prone to transform into fluorides by reacting with HF impurity in electrolyte, and further transform into ternary compounds.¹⁹ These results indicate that such conventional coating materials can be consumed over time or later their role of surface passivation. In contrast, solid electrolyte has more stable crystal structures compared with such binary oxides that can maintain superior chemical stability in contact with liquid electrolytes. Therefore, our proposed approach will significantly improve the stability of both Ni-rich NMC and Mn-rich NMC cathode materials.

### Method

### Co-Precipitation of Ni-Rich and Mn-Rich NMC Oxides

Most of the commercial grade NMC oxides for current Li-ion batteries for electric vehicles are produced from mixed transition metal precursors via two-step process. The first step is a co-precipitation reaction of mixed transition metal salts in a stirred solution of hydroxide or carbonate, which results in precipitation of M(OH)₂ or MCO₃ (M=Ni, Mn, and Co) with a uniform cation distribution. In the second step, the hydroxide or carbonate precursor is mixed with LiOH or Li₂CO₃, and calcined at high temperature to form oxide products. The electrochemical performance of NMC cathodes are strongly affected by the physicochemical properties of the intermediate precursors such as phase purity, morphology, size distribution, tab density, and cation distribution. Therefore, it is of critical importance to have fine control over the nucleation and precipitation process of mixed metal salts. Such precise process control over the complex co-precipitation of multi-cation system can be achieved by using specially designed continuously stirred tank reactor, where the reaction temperature, stirring speed, and reactant feeding rate can be precisely regulated.

### Wet-Chemical Coating/Blending Solid-Electrolyte on NMC Oxides

Interfacial degradation has been mitigated with strategies that include surface coatings to promote electron conduction or act as an ion-conducting electrolyte. In particular, oxides such as Al₂O₃^{1-2,3,4}, ZrO₂^{4,5}, TiO₂⁴, and MgO⁶ and phosphates such as AlPO₄⁷ have been investigated for Ni-rich layered oxides to act as buffers, prevent phase transformations during cycling (i.e. from hexagonal to monoclinic), and protect the active cathode material from degradation due to deleterious side reactions at the particle interface.

An additional advantage of using ionically conducting solid electrolytes such as Li₇La₃Zr₂O₁₂ (LLZO), Li_{1.4}Al_{0.4}Ti_{1.6}(PO₄)₃ (LATP), Li_{0.5}La_{0.5}TiO₃ (LLTO), Li₃PO₄, and Li₂HPO₄ include the ability of the coating material to be reduced while maintaining surface protection and ion conductivity. Recently, density functional theory has demonstrated that Li₃PO₄ and Li₂HPO₄ coating on high voltage cathode materials maintain chemical stability in all-solid configuration⁸. These coating materials are selected for their relative ease of synthesis and inexpensive precursors, which is critical for scalability and manufacturing. The oxidation limits of Li₃PO₄ and Li₂HPO₄ are high enough to be electrochemically stable (i.e. >4.2 V) and low activation energy for ion migration (0.33 eV-0.40 eV), which indicate reasonable ionic conductivity. Comparable energy barriers for similar structures indicate ˜10⁻⁶ S/cm to 10⁻⁸ S/cm for perfectly crystalline materials. We anticipate that materials for coatings will deviate far from the crystalline state. The anticipated glassy state will increase expected ionic conductivity values from DFT calculations. Previous work on Li₃PO₄ coated LiFePO₄ has demonstrated stabilization of LFP, despite inhomogeneous Li₃PO₄ coating in carbonate-based electrolytes.

Among various solid-electrolyte materials, garnet Li₇La₃Zr₂O₁₂ (LLZO), NASICON Li₁₊ₓAlₓTi₂₋ₓ(PO₄)₃ (LATP), and perovskite Li₃ₓLa_{(2/3)-x}TiO₃ (x=0.11) (LLTO) are considered in our study based on its promising Li-ion conductivity, chemical stability in contact with air/moisture, and electrochemical stability at high-voltages (≥4.3 V_{vs.Li}). These properties make solid electrolytes as attractive coating agents for cathode materials. For example, Li-ion conductivity of these solid electrolytes are in a range of 0.1-1 mS/cm at room-temperature,¹¹ which is few orders of magnitude higher than that of LiAlO₂, (5.6×10⁻⁵ mS/cm)⁸, which is lithiated form of Al₂O₃ coating agent.

Schematics of the proposed stabilization concepts are shown in FIG. 1A to FIG. 1C. It is based on tailoring the cathode surface with a solid-electrolyte overlay coating at either particle or electrode level using various technologies. The solid electrolyte coating offers improved stability and Li-ion transport of coating layer on the cathodes compared with conventional coating materials, which will be beneficial to the LIB performances.

### Physical Adsorption on NMC Oxides

Solid-electrolyte overlay coating concept to stabilize the cathode electrode surface, improving cycle life and enabling the adoption of new lower-cost cathodes that promise higher specific energies and reduced reliance on expensive and critical raw materials.

Among various ceramic electrolyte materials, LLZO, LATP, and LLTO will be considered in this work based on their promising Li-ion conductivity, chemical stability in contact with air/moisture, and electrochemical stability at high-voltages (>4.3 V_{vs.Li}). These promising properties make the solid electrolytes as attractive coating agents for cathodes. For example, Li-ion conductivity of these solid electrolytes are in a range of 0.1-1 mS/cm at room-temperature,² which is few orders of magnitude higher than that of LiAlO₂, (5.6×10⁻⁵ mS/cm)³, which is lithiated form of typical Al₂O₃ coating agent. Also conventional binary- or ternary-oxide coating on cathode serve as scavenging agents that sacrificially react with HF in electrolyte and protect the cathodes. However, during the process, such oxide coating layer will be consumed and transform into metal fluorides, which not only weakens the passivation but increases the cell impedance due to insulating properties of metal fluorides. In contrast, ceramic electrolyte serves as stable physical barrier without the phase transformation during extended LIB cycling.

Strategies for applying cost-effective solid-electrolyte overlay coatings to the cathode electrode will be evaluated. Solid-electrolyte powders including LLZO, Li_{1.3}Al_{0.3}Ti_{1.7}(PO₄)₃ (LATP), and Li₃PO₄ will be synthesized and their microstructures (i.e., particle size, surface area) tailored for different coating approaches. Two approaches were be evaluated for applying an overlay coating to the surface of the cathode electrode tape: aerosol-spray, roll-to-roll deposition, or the casting and lamination of thin electrolyte tape.

Solid-State Electrolytes Synthesized with Ionic Conductivity (>10⁻⁶ S/cm).

The solid-electrolyte powders listed can be manufactured to support coating development.

Commercially available Li₃PO₄ can be purchased for comparison and benchmarked with Li₃PO₄ synthesized in-house in which LiOH and H₃PO₄ are reacted at 40° C. to produce Pmn2₁ Li₃PO₄. Crystallinity and particle size can be tuned and accelerated synthesis can be carried out via microwave-assisted heating.

LLZO, LLTO and LATP can be synthesized via a solid-state process. The calcination profile and processing can be carefully controlled to prevent Li loss from the material. After calcination, XRD can be performed to confirm phase purity and structure, and the powder attrition milled to the required particle size for the coating application.

Solid-Electrolyte Coating that Achieves a Uniform, Defect-Free Coating (Thickness 10-20 μm) on the Cathode Surface.

Three strategies for applying a solid-electrolyte overlay coating to the cathode electrode surface were be investigated:

Aerosol-Spray Deposition (ASD): The ASD process is a cost-effective, high-versatile coating process that is ideally suited for applying a range of uniform coatings with thicknesses between 5 and 50 microns.

Roll-to-roll Coating: we can apply the solid electrolyte slurry onto the cathode using the industry standard roll-to-roll coating process. First, simple cathode can be prepared by using the roll-to-roll coater with target thicknesses (50-100 μm). Second, slurry made with solid electrolyte, PVdF, and NMP can be coated again on the simple cathode. The size of solid electrolyte powders in the slurry, slurry viscosity, dry thickness of solid electrolyte layer, and calendering condition (i.e., porosity) can be optimized in terms of cell impedance, micro structure, passivation of cathodes, and cycle/shelf life of battery cells.

Tape Casting: Solid electrolyte powders can be formulated into tape-cast slurries and thin (˜10 μm thick) tapes cast. The tape laminated with the cathode tape to form a multi-layer tape consisting of a cathode layer and adherent solid-electrolyte coating layer. As with the ASD processes critical process parameters, including the thickness and number of layers of solid electrolyte tape (overall electrolyte coting thickness), lamination pressure and temperature, and tape-casting formulation can be efficiently optimized through a Design of Experiments study. Tape thicknesses between 10 and 50 microns can be uniformly cast on caster and multi-layer laminates fabricated.

The uniformity and quality of the coated electrodes can be assessed by visual inspection, and top-down and cross-section SEM analysis. An automated pull-test based on ASTM standard D3359-17 can be used to assess the adhesion of the coating to the cathode.

In addition, the blending of high surface area solid-electrolyte powders with the cathode powder to form a powder coating can be evaluated as an alternative approach.

### Characterization of Coated Electrode:

Promising coatings can be down-selected for further characterization. Surface characterization techniques such as Raman spectroscopy and X-ray photoelectron spectroscopy can be used to elucidate the chemical and structural changes in the active material as well as the coating. Amorphization of the coating can be investigated to elucidate the effects of coating thickness, homogeneity, and chemical stability. This characterization work can provide a deeper understanding of the interactions between the electrode and coating and help identify potential degradation mechanisms and opportunities to improve the technology.

### Performance Testing

Coating approaches can be incorporated into half and full-cell coin-cells and cell performance (specific capacity, cycle life) evaluated versus the baseline uncoated electrodes. A subset of coated cathode cells can omit the separator component to assess the feasibility of the solid-electrolyte coating eliminating the need for the separator. Based on results a coating configuration can be down-selected and fabricated into single layer pouch (SLP) cells for additional performance testing.

Performance Improvement Demonstrated for Coated Vs. Uncoated Cathodes.

Promising, uniform and defect-free coated electrodes can be fabricated into coin cells (both half- and full-cell) and tested using the same baseline cell chemistries and cell testing protocols. This can enable a direct comparison between coated and uncoated electrodes. Meaningful improvement defined by at least 10 percent enhancement in initial specific capacity and/or greater than 25 percent improvement in cycle-life based on coin-cell testing.

### Viability of the Coating Approach Eliminating the Need of the Polymer Separator Determined

In addition, a sub-set of cells can be fabricated without the separator to determine whether the solid-electrolyte coating can act as an integrated separator.

### Single Layer Pouch Cell Testing of Down-Select Coated Cathode Completed.

Based on the test result a cell configuration with and without coated cathodes can be down-selected and made into single-layer pouch (SLP) cells. After appropriate formation cycling the SLP cells can be tested to help define the performance value proposition for the coating technology.

### Results

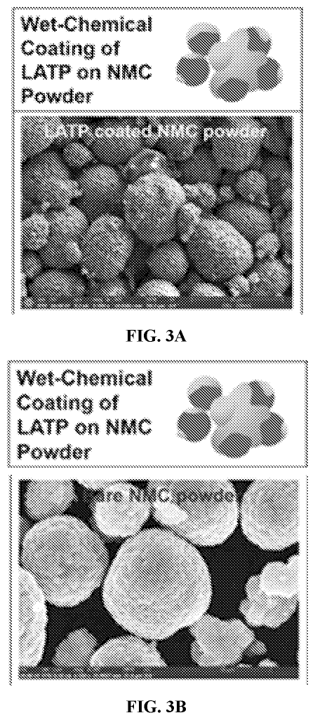

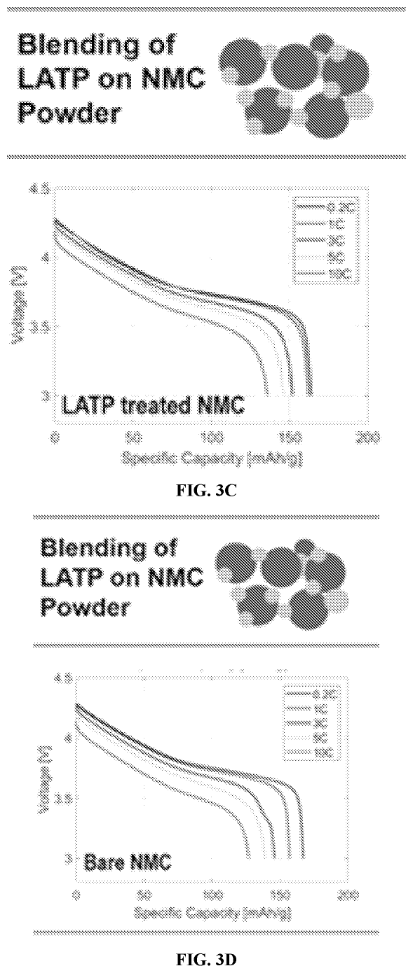

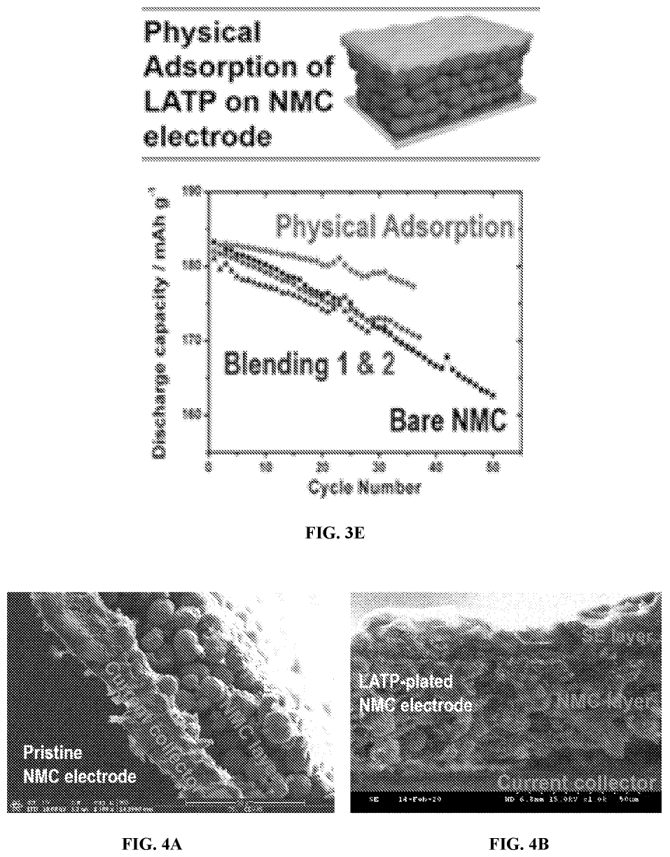

We have examined different methods of tailoring the surface of NMC cathodes: (1) wet-chemical (e.g. sol-gel) solid-electrolytes coating on NMC powder, (2) physical blending of solid-electrolyte on NMC powder, and (3) physical adsorption of solid-electrolyte on NMC electrode. Each approach can provide unique microstructure and electrochemical properties. For the (1) wet-chemical coating approach, we are using sol-gel, hydrothermal, and solvothermal synthesis methods to coat the liquid precursors of solid-electrolytes on top of LATP (FIG. 3A to FIG. 3E). For the (2) physical blending of solid-electrolyte on NMC powder, small solid-electrolyte particles will be adsorbed on large, spherical NMC particles. This approach was found to deliver improved power capability of NMC cathodes. For the (3) physical adsorption of solid-electrolyte on NMC electrode, it was found to be most beneficial in the cycle life of battery cells. As each approach offers different advantages and requires diverse optimization strategies, we first perform design-of-experiments to screen and develop the technology.

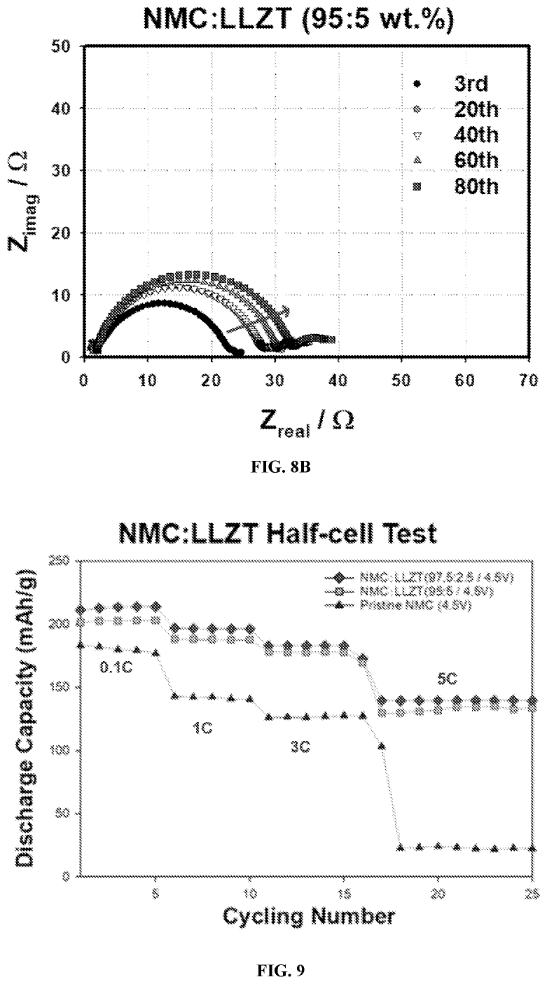

The data (FIG. 8A to FIG. 8B) indicates that the solid-electrolyte coating on cathode active material powder facilitated the charge-transfer kinetics and thereby enhanced the rate capability of battery cells. In addition, the solid-electrolyte coating on the NMC622 electrode resulted in the improved cycle life while operating at high voltage (4.5 V_{vs.Li} upper cut-off) compared with the baseline NMC622 cathode. Since the baseline NMC622 powder has traditional coating on it, this addresses a critical issue associated with the conventional coating that cannot effectively passivate the surface of cathode particles at high voltages. As shown from the data, each approach offers different advantages and requires diverse processing and optimization strategies.

### Surface Characterization

Interfacial connectivity between solid-state electrolyte and active electrode material is key for maintaining high ionic conductivity and low resistance. Surface characterization techniques such as XPS, Raman spectroscopy, SEM, and TEM will provide insight into homogeneity of LATP coating and particle size distribution. A range of discreet wt. % (1-10 wt. %) can be used to optimize coating conditions for the NMC variants. Given the low wt. %, it is expected that X-ray diffraction can be carried out to confirm phase purity of the bulk R3̅m as-prepared solid-state electrolyte. However, Raman spectroscopy,¹⁴ XPS, and LATP can be carried out to confirm and characterize coating thickness, which is expected to possess low Bragg diffraction signal.

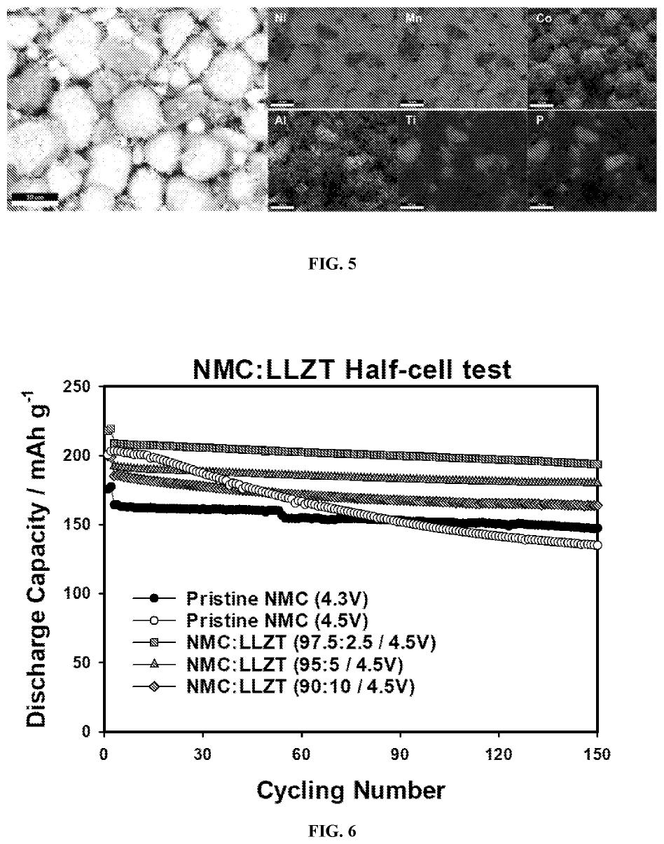

FIG. 4A to FIG. 4B shows the cross-sectional SEM images of the pristine- and the LATP-coated NMC cathodes. It shows LATP layer is plated on the top of the NMC electrode. FIG. 5 shows the SEM-EDX images of LATP/NMC blended electrode. The specific elements (Ni, Mn, Co, Al, Ti, and P) are identified by EDX.

### Performance Testing

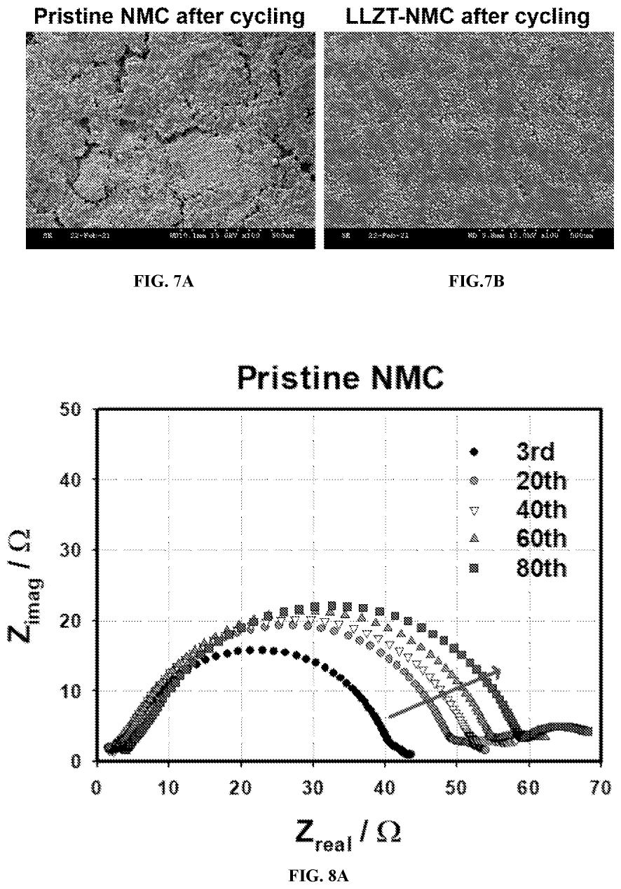

Physical blending the ionically conducting solid-electrolyte and the electrode active material can improve the cycle life as shown in FIG. 6. The blending method can be evaluated by manufacturing half-cells. The optimized amount of the ionic-conductive material can be determined by varying the ratio of Li-conductive solid-electrolyte and the active materials. Meaningful improvement defined by at least 10 percent enhancement in initial specific capacity and/or greater than 25 percent improvement in cycle-life based on coin-cell testing. The collected SEM images demonstrate blending solid-electrolyte can effectively reduce the generation of the cracks on the electrode during the extensive cycles (FIG. 7A to FIG. 7B). FIG. 8A to FIG. 8B exhibits that ionically conductive material can reduce the impedances of the cells by adding the conductive ingredient. As the results, the blending Li-ionic conductor effectively reduce the cell impedances. FIG. 9 shows the rate-capabilities of the pristine and LLZT-mixed NMC electrodes. Mixing LLZT can significantly improve the rate-capabilities.

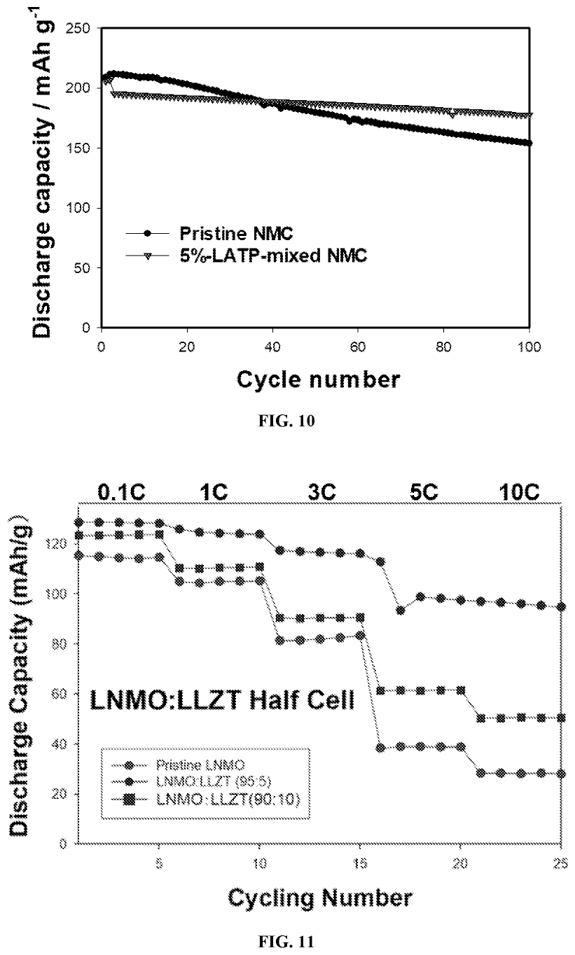

FIG. 10 shows the cycle abilities of the pristine and LATP-mixed NMC cathodes pairing with graphite anodes in coin type cells electrodes. This implies additional LATP ionic conductor improved the battery performance. FIG. 11 shows the rate-capabilities of the pristine and LLZT-mixed LNMO cathodes. The results show that Li-ionic conductor works even when the cathode materials were changed.

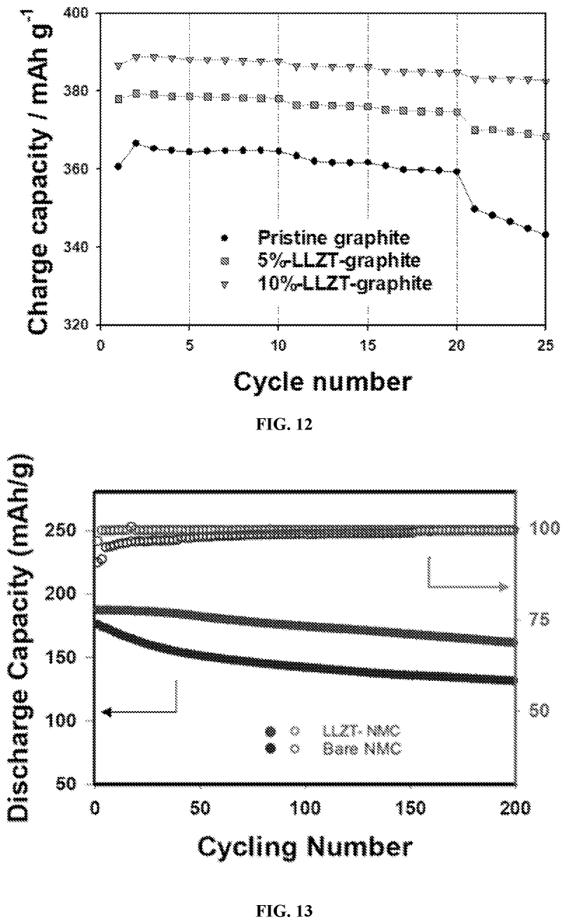

FIG. 12 shows rate-capabilities of the pristine and LLZT-mixed graphite anode. LLZT-mixed electrodes show the better performances than the pristine graphite anode. It exhibits this approach can improve the battery performance even when it is applied to the anode part.

FIG. 13 shows the cycle abilities of the pristine and LATP-mixed NMC cathodes pairing with graphite anodes in pouch type cells electrodes. This implies additional LATP ionic conductor improved the battery performance.

### Moisture Contamination Test for LLZT Mixed NMC Cathodes

The high-voltage operation of Li-ion battery cathodes leads to parasitic reactions at cathode-electrolyte interfaces and can produce moisture and hydrofluoric acid (HF) because of solvent decompositions. HF can attract both cathodes and anodes which results in unwanted transition metal dissolutions from cathodes and/or degradation of solid-electrolyte interphase (SEI) layer on graphite anodes.

Sharafi et al., J. Mater. Chem. A, 2017, 5, 13475-13487, reported that the Li₇La₃Zr₂O₁₂ (LLZO) is moisture sensitivity material and can consume the residual water by scavenging protons by following reaction routes:

Li₇La₃Zr₂O₁₂+xH₂O→Li₇₋ₓHₓLa₃Zr₂O₁₂+xLiOH [1]

Li₇La₃Zr₂O₁₂+xH₂O→Li₇₋₂ₓH₂ₓLa₃Zr₂O₁₂+xLi₂O [2]

Therefore, moisture in liquid electrolyte can be scavenged by the LLZT solid electrolyte in the LLZT-mixed NMC electrodes. To investigate the effect of the LLZT additive on preventing cell degradation under the presence of such moisture, we intentionally contaminated 10 mL electrolyte by adding 50 μL of deionized water.

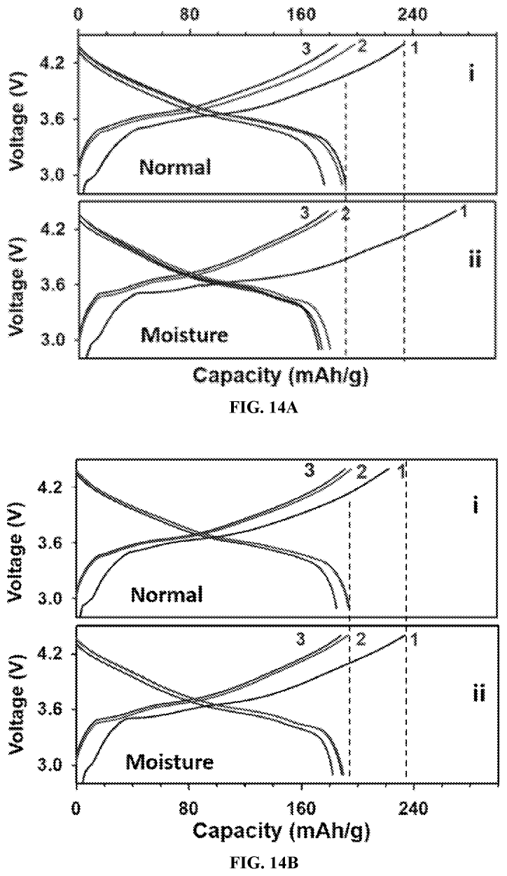

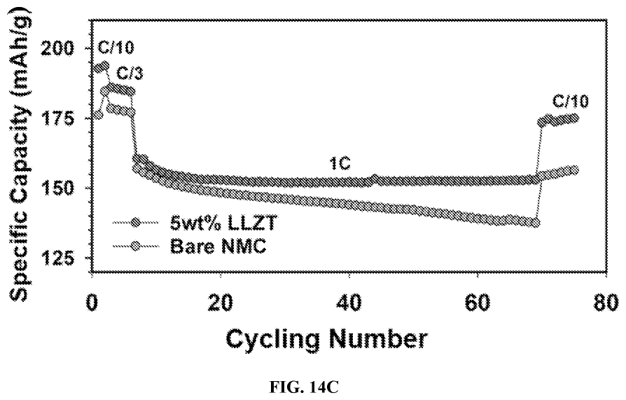

FIG. 14A compares the cathode/graphite full-cell performances of bare NMC cathodes using (i) normal electrolyte and (ii) moisture-contaminated electrolyte. FIG. 14B compares the cathode/graphite full-cell performances of 5 wt % LLZT mixed NMC cathodes using (i) normal electrolyte and (ii) moisture-contaminated electrolyte. The bare NMC cathode cell showed larger irreversible charging capacity at the 1^{st} cycle, followed by noticeable discharge capacity loss when the moisture-contaminated electrolyte was used. The high irreversible charging is caused by parasitic reactions at electrode-electrolyte interfaces at the presence of moisture in the electrolyte. In contrast, the 5 wt % LLZT mixed NMC cathode maintained charge/discharge cycles even when the moisture-contaminated electrolyte was used. FIG. 14C also showed a repeatedly improved capacity retention of the 5 wt % LLZT mixed NMC cathode in presence of the moisture. This result demonstrates the positive effect of LLZT in terms of scavenging moisture and stabilizing electrode-electrolyte interphases.

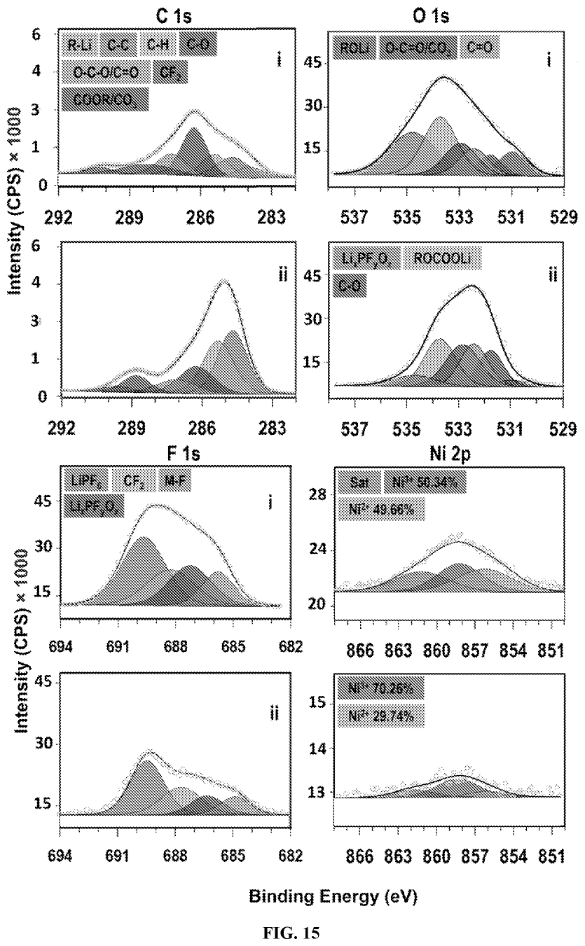

The surface of bare and 5 wt % LLZT mixed NMC cathodes were analyzed by X-ray photoelectron spectroscopy (XPS) after cycling full-cells using the moisture-contaminated electrolyte, as shown in FIG. 15. In C is spectra, the C—C/C—H peak intensity of 5 wt % LLZT mixed NMC cathode is lower than that of pristine NMC indicating that LLZT mixing suppressed parasitic reactions and reduced the thickness of cathode-electrolyte interphase (CEI) layer deposited onto the cathode surface. Comparing with the O 1s spectra, the 5 wt % LLZT mixed NMC cathode also had a significantly lower LiₓPF_{y}O_{z} peak intensity at 534.5 eV, which is final product of moisture attack on LiPF₆ electrolyte salt (see Lux, S. F., et al., Electrochem. Commun., 2012, 14 (1), 47-50; and Kawamura, T., et al., J. Power Sources, 2006, 156 (2), 547-554).

LiNi_{0.5}Mn_{1.5}O₄ High-Voltage Cathode Performance

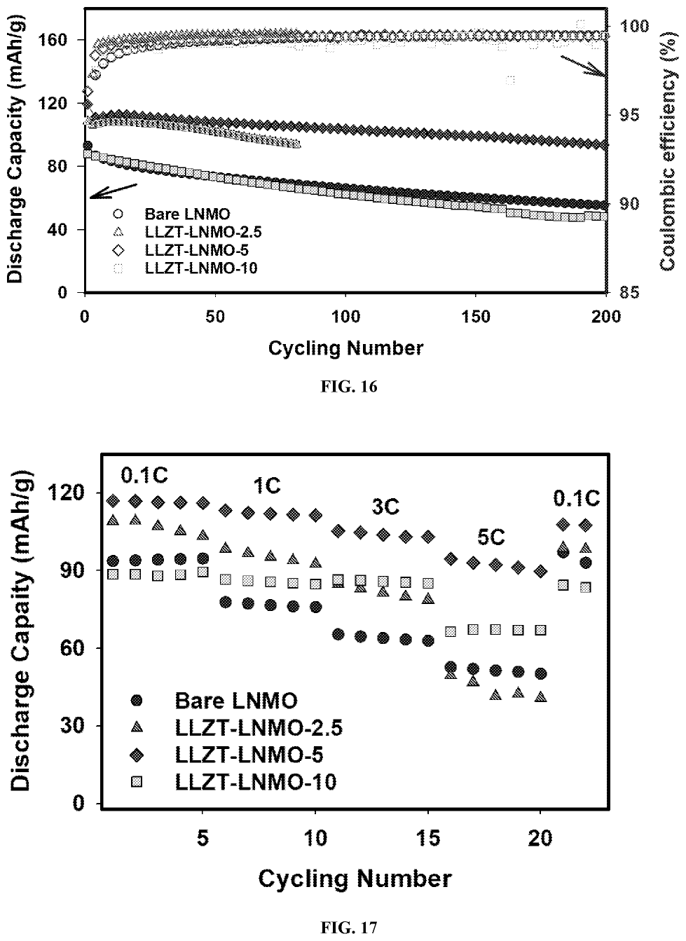

In addition to the NMC cathode, the effect of solid electrolyte was examined for the LiNi_{0.5}Mn_{1.5}O₄ (LNMO) spinel cathode having a high operating voltage of ˜4.7 V_{vs.Li}. The effect of LLZT on the cycling performance of LNMO cathodes in full-cells and coulombic efficiency curves of all the samples are shown in FIG. 16. The 5 wt % LLZT mixed LNMO cathode delivered the optimal discharge capacity. In addition, the 5 wt % LLZT mixed LNMO cathode offered C-rate capability superior to that of the bare NMC cathode, as shown in FIG. 17.

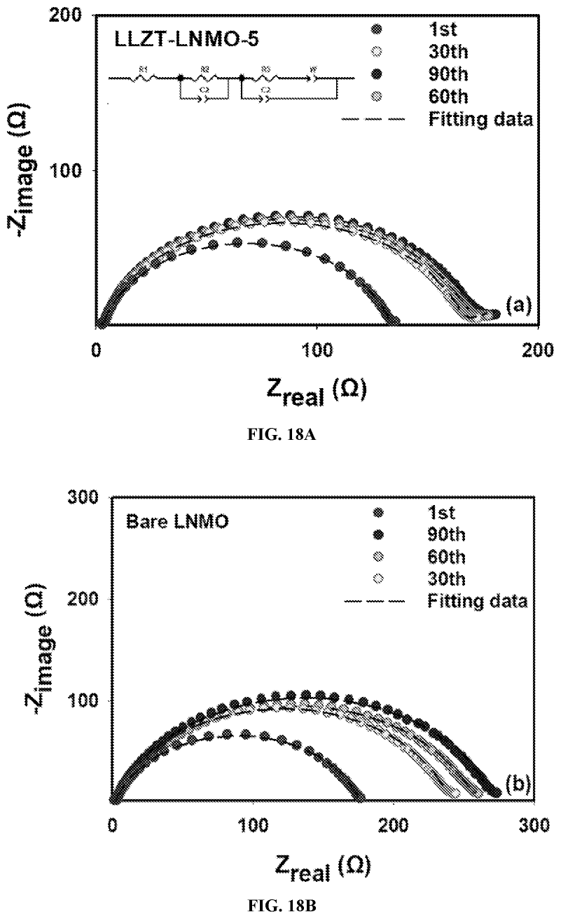

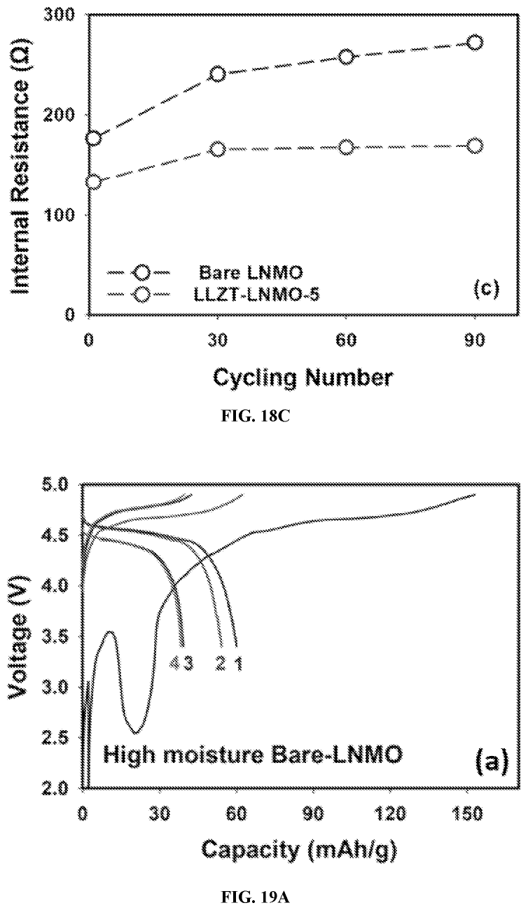

FIGS. 18A and 18B compares Nyquist plots of bare and 5 wt % LLZT mixed LNMO cathodes in half-cells. Although both cells exhibited a trend of increasing impedance with cycle number due to continuous electrolyte decomposition, FIG. 18C clearly showed a lower cell impedance by mixing 5 wt % LLZT to LNMO cathode.

### Moisture Contamination Test for LLZT Mixed LNMO Cathodes

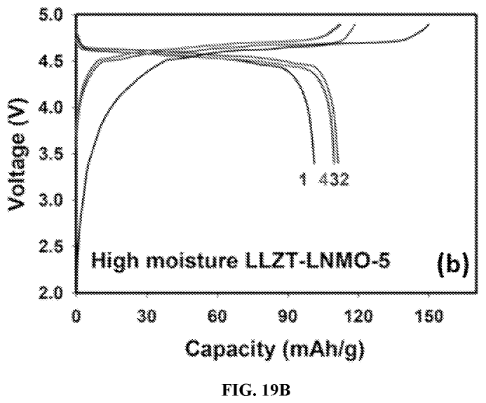

As discussed earlier, the LLZT solid electrolyte can scavenge moisture and proton in liquid electrolyte. the effect of LLZT on the stability of LNMO cathodes at presence of moisture in electrolytes was examined. 50 μL of deionized water was added to 10 mL of organic electrolyte to produce the moisture-contaminated electrolyte. The Bare LNMO suffered from the moisture as evidenced by low discharge capacity and Coulombic efficiency as shown in FIG. 19A. In particular, significant voltage fluctuation was observed during the 1^{st} charge process due to parasitic reactions of moisture in the cells. In contrast, the 5 wt % LLZT mixed LNMO cathode still delivered stable voltage profiles during the repeated cycling in full-cell. This result again provide a strong evidence that LLZT scavenges and suppress the unwanted reactions between electrodes' surface and HF.

### REFERENCES

1. Li, D.; Kato, Y.; Kobayakawa, K.; Noguchi, H.; Sato, Y. Preparation and Electrochemical Characteristics of LiNi1/3Mn1/3Co1/3O2 Coated with Metal Oxides Coating. J. Power Sources 2006, 160 (2 SPEC. ISS.), 1342-1348.
2. Myung, S. T.; Izumi, K.; Komaba, S.; Sun, Y. K.; Yashiro, H.; Kumagai, N. Role of Alumina Coating on Li—Ni—Co—Mn—O Particles as Positive Electrode Material for Lithium-Ion Batteries. Chem. Mater. 2005, 17 (14), 3695-3704.
3. Liao, J. Y.; Manthiram, A. Surface-Modified Concentration-Gradient Ni-Rich Layered Oxide Cathodes for High-Energy Lithium-Ion Batteries. J. Power Sources 2015, 282, 429-436.
4. Wise, A. M.; Ban, C.; Weker, J. N.; Misra, S.; Cavanagh, A. S.; Wu, Z.; Li, Z.; Whittingham, M. S.; Xu, K.; George, S. M.; et al. Effect of Al2O3 Coating on Stabilizing LiNi0.4Mn0.4Co0.2O2 Cathodes. Chem. Mater. 2015, 27 (17), 6146-6154.
5. Song, B.; Li, W.; Oh, S. M.; Manthiram, A. Long-Life Nickel-Rich Layered Oxide Cathodes with a Uniform Li2ZrO3 Surface Coating for Lithium-Ion Batteries. ACS Appl. Mater. Interfaces 2017, 9(11), 9718-9725.
6. Yoon, W. S.; Nam, K. W.; Jang, D.; Chung, K. Y.; Hanson, J.; Chen, J. M.; Yang, X. Q. Structural Study of the Coating Effect on the Thermal Stability of Charged MgO-Coated LiNi0.8Co0.2O2 Cathodes Investigated by in Situ XRD. J. Power Sources 2012, 217, 128-134.
7. Tan, K. S.; Reddy, M. V.; Rao, G. V. S.; Chowdari, B. V. R. Effect of AlPO4-Coating on Cathodic Behaviour of Li(Ni 0.8Co0.2)O2. J. Power Sources 2005, 141 (1), 129-142.
8. Xiao, Y.; Miara, L. J.; Wang, Y.; Ceder, G. Computational Screening of Cathode Coatings for Solid-State Batteries. Joule 2019, 3 (5), 1252-1275.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

1. A solid electric conductor comprising two discrete populations of particles intermixed, wherein the first population of particles comprises an ionically conducting solid-electrolyte, and the second population of particles comprises an electrode active material.

2. The conductor of claim 1, wherein the electrode active material comprises a cathode material.

3. The conductor of claim 1, wherein the electrode active material comprises an anode material.

4. The conductor of claim 1, wherein the first population of particles and the second population of particles are present in a weight ratio of from 1:1000 to 1:5.

5. The conductor of claim 1, wherein the first population of particles exhibits an average particle size of from 20 nm to 30 μm.

6. The conductor of claim 1, wherein the second population of particles exhibits an average particle size of from 20 nm to 30 μm.

7. The conductor of claim 1, wherein the first population of particles exhibits an average particle size and the second population of particles exhibits an average particle size, and wherein the average particle size of the first population of particles is from 0.005 to 200 of the average particle size of the second population of particles.

8. The conductor of claim 1, wherein the first population of particles, the second population of particles, or any combination thereof have a spherical shape.

9. The conductor of claim 1, wherein the first population of particles are physically blended with the second population of particles.

10. The conductor of claim 1, wherein the first population of particles are wet-chemically coated on the second population of particles.

11. The conductor of claim 1, wherein the first population of particles are physically absorbed by the second population of particles.

12. The conductor of claim 1, wherein the ionically conducing solid-electrolyte comprises Li₇La₃Zr₂O₁₂ (LLZO), Li_{1.4}Al_{0.4}Ti_{1.6}(PO₄)₃ (LATP), Li_{0.5}La_{0.5}TiO₃ (LLTO), Li₃PO₄, Li₂HPO₄, or Li_{6.75}La₃Zr_{1.75}Ta_{0.25}O₁₂ (LLZT).

13. The conductor of claim 1, wherein the electrode active material comprises LiNi_{0.6}Mn_{0.2}Co_{0.2}O₂ (NMC622), LiNi_{0.8}Co_{0.1}Mn_{0.1}O₂ (NMC811), LiNi_{1/3}Mn_{1/3}Co_{1/3}O₂ (NMC111), LiNi_{0.5}Mn_{1.5}O₄ (LNMO), LiNi_{0.5}Mn_{1.5-x}TiₓO₄, or LiNi_{0.8}Co_{0.15}Al_{0.05}O₂ (NCA).

14. The conductor of claim 1, wherein the electrode active material is manganese rich.

15. The conductor of claim 14, wherein the electrode active material is represented by formula I:
Li_{1+z}(Ni_{1-x-y}MnₓCo_{y})_{1-z}O₂
wherein y is less than 0.12, x is greater than 0.5, and z is 0.13.

16. The conductor of claim 14, wherein the electrode active material is Li_{1.13}Ni_{0.28125}Mn_{0.53125}Co_{0.1875}O_{2.13}.

17. The conductor of claim 1, wherein the electrode active material is nickel rich.

18. The conductor of claim 17, wherein the electrode active material is represented by formula II:
LiNi_{1-x-y}MnₓCo_{y}O₂
wherein x is less than 0.1; and y is less than 0.1.

19. The conductor of claim 1, wherein the electrode active material is represented by Formula III:
LiNi₁₋ₓCo_{0.5x}Mn_{0.5x}O₂
wherein x is 0.15 or 0.1.

20. The conductor of claim 1, wherein the electrode active material is LiNi_{0.85}Co_{0.075}Mn_{0.075}O₂, LiNi_{0.9}Co_{0.05}Mn_{0.05}O₂, or LiNi_{0.5}Mn_{1.5-x}TiₓO₄; LiNi_{0.8}Co_{0.15}Al_{0.05}O₂.

21. The conductor of claim 1, wherein the electrode active material further comprises binder, carbon conductive material, a passivation layer, or any combination thereof.

22. A method of making a solid electric conductor, the method comprising:
contacting a first population of particles comprising an ionically conducting solid-electrolyte with a second population of particles comprising an electrode active material.

23-46. (canceled)

47. A battery comprising:
an anode and a cathode disposed in a housing; and
an electrolyte disposed between the cathode and the anode providing an ionically conductive pathway between the anode and the cathode;
wherein the anode, the cathode, or any combination thereof comprises an electrode active material and an ionically conducting solid-electrolyte;
wherein the cathode material comprises a layered structured cathode material; and
wherein the ionically conducting solid-electrolyte is present in an amount effective such that the battery exhibits greater than 80% capacity retention during 1000 cycles above 4.3V.

48-53. (canceled)
